(19) United States
(12) Patent Application Publication
(10) Pub. No.: US 2013/0137889 A1
(43) Pub. Date: May 30, 2013

(54) STRECKER REAGENTS, THEIR DERIVATIVES, METHODS FOR FORMING THE SAME AND IMPROVED STRECKER REACTION

(71) Applicants: Guigen Li, Lubbock, TX (US); Xiangzhen Sun, Suzhou City Jiangsu (CN); Huabing Chen, Suzhou City Jiangsu (CN)

(72) Inventors: Guigen Li, Lubbock, TX (US); Xiangzhen Sun, Suzhou City Jiangsu (CN); Huabing Chen, Suzhou City Jiangsu (CN)

(73) Assignees: NANJING UNIVERSITY, Nanjing, Jiangsu (CN); TEXAS TECH UNIVERSITY, Lubbock, TX (US); NOWA PHARMACEUTICALS CO., LTD., Suzhou City, Jiangsu (CN)

(21) Appl. No.: 13/702,060

(22) PCT Filed: Mar. 26, 2010
(86) PCT No.: PCT/CN2010/071352

§ 371 Date: Dec. 4, 2012

(51) Int. Cl. C07F 9/6584; C07F 5/06; C07F 9/6574

(52) U.S. Cl. CPC C07F 9/65848; C07F 9/65742; C07F 5/068
USPC 556/175; 558/84; 558/386

(57) ABSTRACT

Strecker reagents, their derivatives and methods for forming the same and improved Strecker reaction are provided. The electrophiles for asymmetric Strecker reaction include achiral N-phosphorazides, N-phosphoramides, N-phosphonyl imines and their derivatives. The nucleophiles for asymmetric Strecker reaction include chiral BINOL-derived azides, amides, imines and their derivatives, the chiral and achiral diol-based cyanides and their derivatives, the chiral and achiral diamine-based cyanides and their derivatives, the chiral and achiral amino alcohol-based cyanides and their derivatives, the Strecker nucleophiles that are derived from chiral and achiral hydroxyl carboxylic acids and amino acids. Methods of forming the electrophile for asymmetric Strecker reaction comprise the reactions with steps of: a) synthesizing phosphoryl chloride from achiral diamine; b) synthesizing phosphorous azide; c) synthesizing phosphoramide; d) synthesizing the corresponding achiral N-phosphonyl imines. The asymmetric catalytic Strecker reaction of new achiral N-phosphonyl imines has been developed to give excellent enantioselectivity (up to >99% ee) and yields (up to >97%).

### FIELDS OF THE INVENTION

The invention relates to the design and synthesis of new Strecker reagents, their derivatives, methods for forming the same. In particular, this invention provides new designer of Strecker reagents of: (1) electrophiles, such as N-phosphonyl imines, N-phosphoryl imines, oxophospholane and oxophosphepine; (2) nucleophiles, such as 1,2-diamine-, BINOL-, amino alcohol- and amino acid-derived Al-carbonitriles and similar derivatives from amino acids and amino alcohols; and (3) the derivatives and precursors of Strecker reagents, such as N-phosphorazides, N-phosphoramides, N-phosphoryl azides, N-phosphoryl amides, and as 1,2-diamine-, BINOL-, aminoalcohol- and amino acid-derived Al-aryl/alkyl acetylides and the methods for forming the same. The invention further relates to the improved Strecker Reaction.

### TECHNICAL BACKGROUND

The Strecker synthesis is a family of chemical reactions of aldehyde- or ketone-derived imine electrophiles with cyanides to form α-aminonitriles (“Advanced Organic Chemistry: Part B”, 2nd Ed. F. A. Carey & R. J. Sundberg) that are subsequently hydrolyzed to give amino-acids or converted to other chemically and biomedically useful building blocks. The study of asymmetric Strecker processes is becoming more important because an increasing number of drugs appear to be chiral. In the meanwhile, imine chemistry has become one of the most important and active topics in modem chemical synthesis, particularly, for asymmetric catalysis (A. G. Doyle, E. N. Jacobsen, Chem. Rev. 2007, 107, 5713-5743; E. Skucas, M.-Y. Ngai, V. Komanduri, M. J. Krische, Acc. Chem. Res. 2007, 40, 1394-1401; S. F. Martin, Pure Appl Chem 2009, 81, 195-204; S. J. Cannon, Angew. Chem. Int. Ed. 2008, 47, 1176-1178). N-protected imines can be utilized as both electrophiles and dienophiles for many asymmetric reactions (D. Enders, J. P. Shilvock, Chem. Soc. Rev. 2000, 29, 359-373; R. M. Williams, A. J. Hendrix, Chem. Rev. 1992, 92, 889-917; R. Bloch, Chem. Rev. 1998, 98, 1407-1438; S. Kobayashi, H. Ishitani. Chem. Rev. 1999, 99, 1069-1094). In these imines, protecting groups (S. J. Zuend, M. P. Coughlin, M. P. Lalonde, E. N. Jacobsen, Nature 2009, 461, 968-70; M. S. Sigman, P. Vachal, E. N. Jacobsen, Angew. Chem. Int. Ed. Engl. 2000, 39, 1279-1281; S. C. Pan, B. List, Org. Lett. 2007, 9, 1149-1151; J. J. Byrne, M. Chvarant, P.-Y. Chavant, Y. Vallee, Tetrahedron Lett., 2000, 41, 873-876) have been proven to be crucial for controlling stereochemsitry and chemoselectivity for a series of asymmetric processes. The development of new imines for general organic and asymmetric synthesis has been demanded. Recently, a variety of N-substituted, achiral N-phosphorazides, N-phosphoramides and N-phosphonyl imines have been synthesized. The resulting N-phosphonyl imines can be utilized for not only for Strecker reactions, but also for many other reactions, such as asymmetric aza-Darzens reaction (Kattuboina A.; Li, G. Tetrahedron Lett. 2008, 49, 1573-1577), asymmetric aza-Henry reaction (Kattuboina, A.; Kaur, P.; Ai, T.; Li, G. Chem. Biol. Drug Des. 2008, 71, 216-223), asymmetric Mannich reaction (a. Han, J.; Ai, T.; Li, G. Synthesis. 2008, 16, 2519-2526; b. Han, J.; Ai, T.; Nguyen, T.; Li, G. Chem. Biol. Drug Des. 2008, 72, 120-126; c. Han, J.; Chen, Z.; Ai, T.; Li, G. Chem. Biol. Drug Des. 2009, 73, 203-208), asymmetric additions of allymagnesium bromides (Kattuboina, A.; Kaur, P.; Nguyen, T.; Li, G. Tetrahedron lett. 2008, 49, 3722-3724), asymmetric additions of Weinreb amide- and malonate-derived enolates (a. Kaur, P.; Nguyen, T.; Li, G. Eur. J. Org. Chem. 2009, 912-916; b. Chen, Z.-X.; Teng, A.; Kaur, P.; Li, G. Tetrahedron Lett., 2009, 50, 1079-1081) and asymmetric addition reaction with lithium aryl/alkyl acetylides (Org. Biomol. Chem., 2010, 8, 1091-1096).

### SUMMARY OF THE INVENTION

The purpose of the application is to provide new Strecker reagents, their derivatives, methods for forming the same and improved Strecker Reaction.

The application provides the technical solution in following aspects:

A electrophile for asymmetric Strecker reaction, the electrophile include achiral N-phosphorazides, N-phosphoramides, N-phosphonyl imines and their derivatives, having the structure of formula (I) respectively:

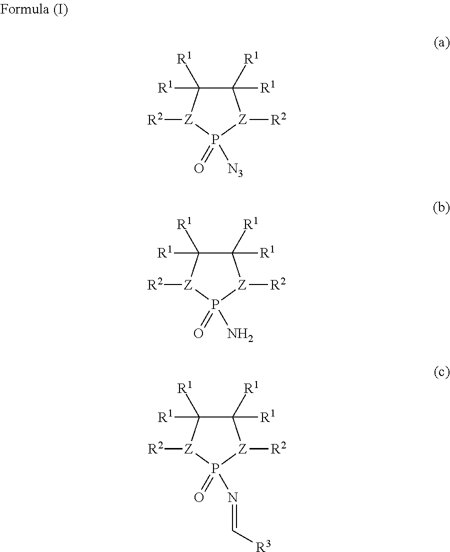

wherein Z═N or CH; R¹ is C1-C20 alkyl, such as i-Pr, Me, Et, Pr, 2-Bu; Aryl; CH₂-Aryl (e.g., Bn); two R¹ groups can be cyclized;

R² is C1-C20 alkyl such as i-Pr, Me, Et, Pr, 2-Bu; Aryl; CH₂-Aryl (e.g., Bn); Ts, Bs, Ms and C1-C20-R—SO₂—, Ar—SO₂—;

R³ is Ar group, such as Ph, 1-Naph-, 2-Naph, 4-Me-Ph, 2-Me-Ph, 4-Cl-Ph, 2-Cl-Ph, 4-Br-Ph, 2-Br-Ph, 4-Br-Ph, 2-Br-Ph, 4-I-Ph, 2-I-Ph, 4-F-Ph, 2-F-Ph, 4-MeO-Ph, 2-MeO-Ph, 4-BnO-Ph, 2-BnO-Ph, 4-AcO-Ph, 2-AcO-Ph, 2-thienyl.

The electrophile, wherein said derivatives are chiral oxophospholanes and oxophosphepines, where two R²-attached nitrogens are replaced by chiral carbons (H—C*—R²); Five-membered ring can be four- and six-membered rings with two chiral carbon centers directly attached onto phosphorus.

The electrophile, wherein the said chiral oxophospholanes and oxophosphepines include (2S,5S) or (2R, 5R) individual enantiomers of a-f:
a. 1-Oxo-2,5-trans-diaryl-N-(arylmethylene)phospholan-1-amine, 1-oxo-2,5-trans-diaryl-N-(alkylmethylene)phospholan-1-amine, 1-oxo-2,5-trans-dialkyl-N-(arylmethylene)phospholan-1-amine, 1-oxo-2,5-trans-dialkyl-N-(alkylmethylene)phospholan-1-amine;
b. 1-Oxo-2,5-trans-diaryl-N-(arylmethylene)-2,3-dihydro-1H-isophosphindol-1-amine, 1-oxo-2,5-trans-diaryl-N-(alkylmethylene)-2,3-dihydro-1H-isophosphindol-1-amine, 1-oxo-2,5-trans-dialkyl-N-(arylmethylene)-2,3-dihydro-1H-isophosphindol-1-amine, 1-oxo-2,5-trans-dialkyl-N-(alkylmethylene)-2,3-dihydro-1H-isophosphindol-1-amine these imines are indeed derived from 2,5-trans-dialkyl (or diaryl)-2-amino-2-oxo-2,3-dihydro-1H-isophosphindole in which ArCH═N— or RCH═N— substitutes NH₂—;
c. 1-Oxo-2,6-trans-diaryl-N-(arylmethylene)phosphinan-1-amine, 1-oxo-2,6-t trans rans-diaryl-N-(alkylmethylene)phosphinan-1-amine, 1-oxo-2,6-trans-dialkyl-N-(arylmethylene)phosphinan-1-amine, 1-oxo-2,6-trans-dialkyl-N-(alkylmethylene)phosphinan-1-amine;
d. 1-Oxo-2,6-trans-diaryl-N-(arylmethylene)-1,4-oxaphosphinan-1-amine, 1-oxo-2,6-trans-diaryl-N-(alkylmethylene)-1,4-oxaphosphinan-1-amine, 1-oxo-2,6-trans-dialkyl-N-(arylmethylene)-1,4-oxaphosphinan-1-amine, 1-oxo-2,6-trans-dialkyl-N-(alkylmethylene)-1,4-oxaphosphinan-1-amine;
e. 1-Oxo-2,6-trans-diaryl-N-(arylmethylene)-2,3-dihydro-1H-phosphenalen-1-amine, 1-oxo-2,6-trans-diaryl-N-(alkylmethylene)-2,3-dihydro-1H-phosphenalen-1-amine, 1-oxo-2,6-trans-dialkyl-N-(arylmethylene)-2,3-dihydro-H-phosphenalen-1-amine, 1-oxo-2,6-trans-dialkyl-N-(alkylmethylene)-2,3-dihydro-1H-phosphenalen-1-amine;
f. Chiral acyclic phosphines such as 1-oxo-N-(arylmethylene)-bis(1′-phenylethyl)-phosphin-1-amine

The electrophile, wherein said derivatives are achiral oxophospholanes and oxophosphepines, where two R²-attached nitrogens can also be replaced by achiral carbons (CH₂), i.e., 2,5- or 2,6-alkyl/aryl groups of the above a-f are replaced by hydrogen.

The electrophile of one of the above, wherein the “P═O” can be “P═S”.

A nucleophile for asymmetric Strecker reaction, the nucleophiles include chiral BINOL-derived azides, amides, imines and their derivatives, having the structure of one of formula (II):

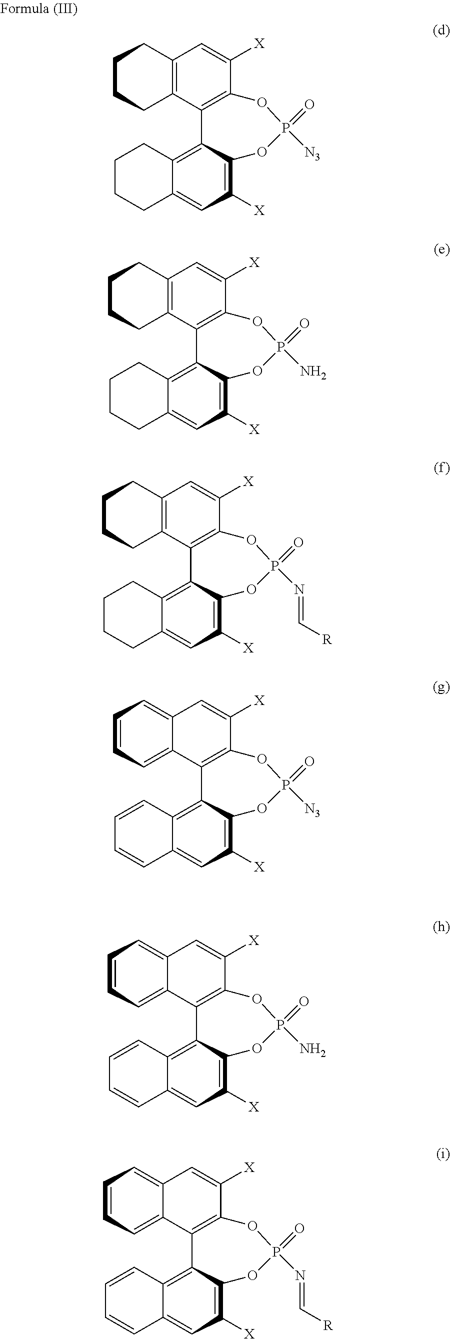

wherein X═H, Alkyl, Aryl group, SiR₃ and SiAr₃; R=alkyl, aryl groups, functional group (such as ester, acetals)-attached alkyl and aryl groups, acetylides; two oxygens of O—P single bonds can be replaced by “N—R” (R=alkyl, aryl groups); two oxygens of O—P single bonds can be replaced “CH₂”; “P═O” can be “P═S” except for (g)-(i) in which X═H; For structure (g) X cannot be H for both P═O and P═S cases.

A nucleophile for asymmetric Strecker reaction, the nucleophile include chiral and achiral diol-based cyanides and their derivatives, having the structure of formula (III):

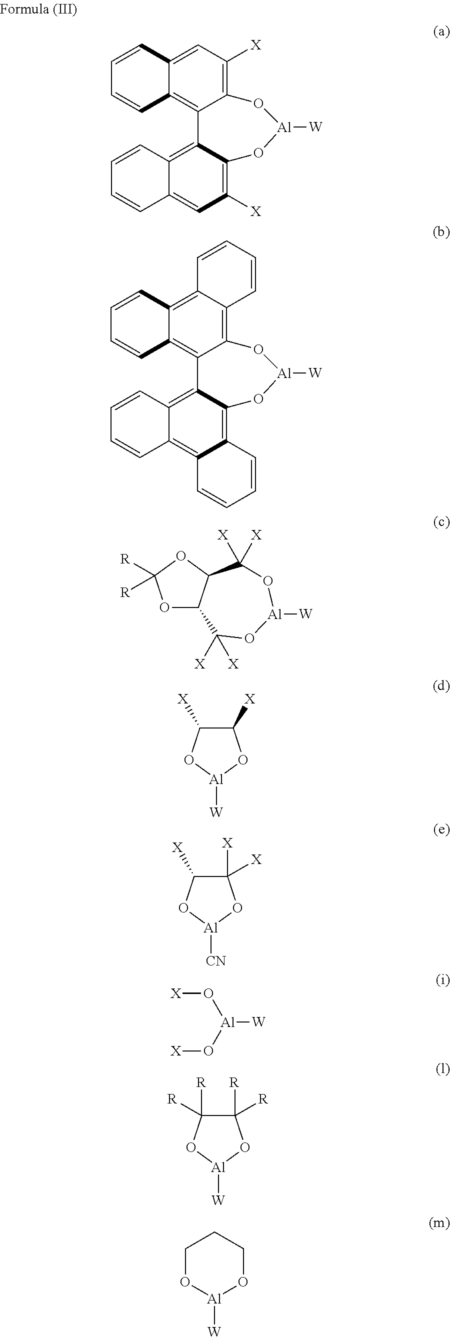

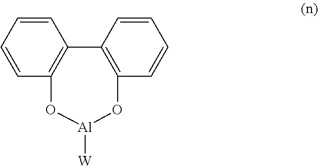

wherein (a)-(b) can be their enantiomers; X=alkyl, aryl, SiR₃ and SiAr₃; W═CN, N₃, I, C≡C—Ar; C≡C—R, C≡C—CH-acetyl; derivatives from 1-(2-hydroxy-5,6,7,8-tetranhydronaphthalen-1-yl)-5,6,7,8-tetranhydronaphthalen-2-ol are also covered;
(c) can be their enantiomers; X=Aryl, Alkyl, W═CN, N₃, I, C≡C—Ar; C≡C—R, C≡C—CH-acetyl; R=Alkyl, Aryl groups; can be different; can be cyclic, two R's are connected;
(d)-(e) can be their enantiomers; and achiral ones where X═H, or, four same X groups are attached on 1, 2-positions; X=Alkyl, Aryl, CR₂(—OR); W═CN, N₃, I, C≡C—Ar; C≡C—R, C≡C—CH-acetyl;

### in (i) X=Alkyl, Aryl, W═CN, N₃;

in (l)-(n) X=Alkyl, Aryl, COOR; W═CN, N₃, I.

The nucleophile for asymmetric Strecker reaction, wherein (d) and (e) of Formula (III) having the structure of one of Formula (III-2):

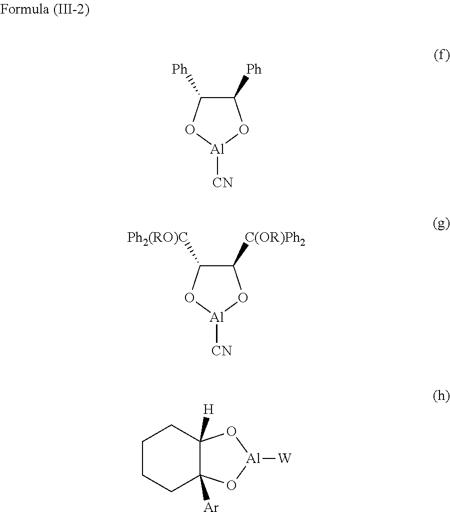

The nucleophile for asymmetric Strecker reaction, wherein (i) of Formula (III) having the structure of one of Formula (III-3):

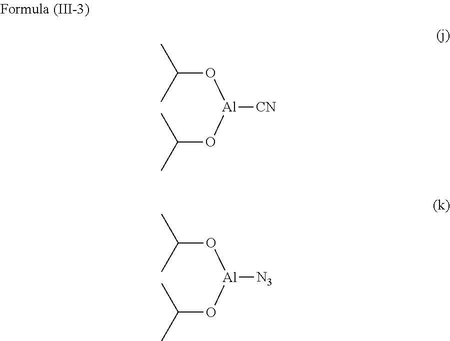

The nucleophile for asymmetric Strecker reaction, wherein (l), (m) and (n) of Formula (III) having the structure of one of Formula (III-4):

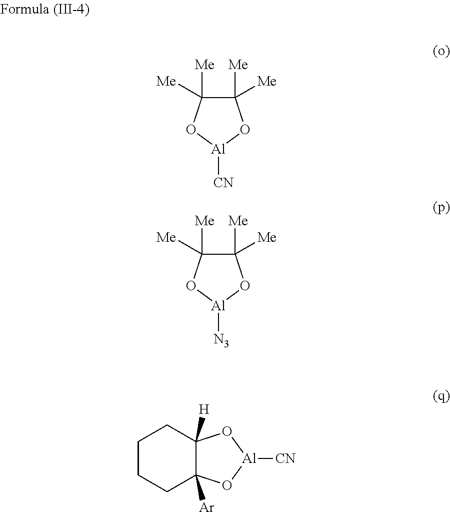

A nucleophile for asymmetric Strecker reaction, the nucleophile include chiral and achiral diamine-based cyanides and their derivatives, having the structure of formula (IV):

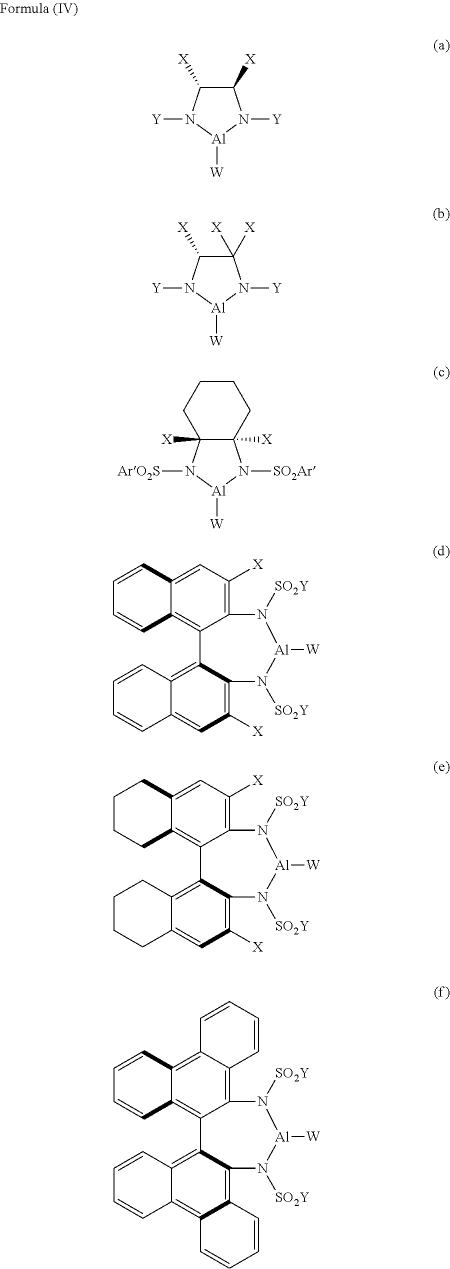

wherein (a)-(b) can be their enantiomers; achiral ones where X═H, or, four identical X groups are attached on 1, 2-positions; X=Aryl, Alkyl; Y=alkyl, aryl and RSO2-; W═CN, N₃, I, C≡C—Ar; C≡C—R, C≡C—CH-acetyl;
(d)-(f) can be their enantiomers; X=alkyl, aryl, SiR₃ and SiAr₃; Y=alkyl, aryl; W═CN, N₃, I, C≡C—Ar; C≡C—R, C≡C—CH-acetyl; 1,3-diamine-derived complexes are also covered.

Nucleophiles for asymmetric Strecker reaction, the nucleophiles include chiral and achiral amino alcohol-based cyanides and their derivatives, having the structure of formula (V):

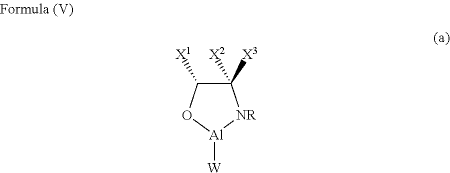

wherein (a) can be their enantiomers; X=Alkyl, Aryl, COOR; W═CN, N₃, I, C≡C—Ar; C≡C—R, C≡C—CH-acetyl, R═H, alkyl, ArSO2-, ROCO— and RCO—; and achiral ones where X═H, or to same X groups are attached on alpha, beta positions; 1,3-amino alcohol-derived complexes are also covered.

The formula (V) having the structure of one of formula (V-2)

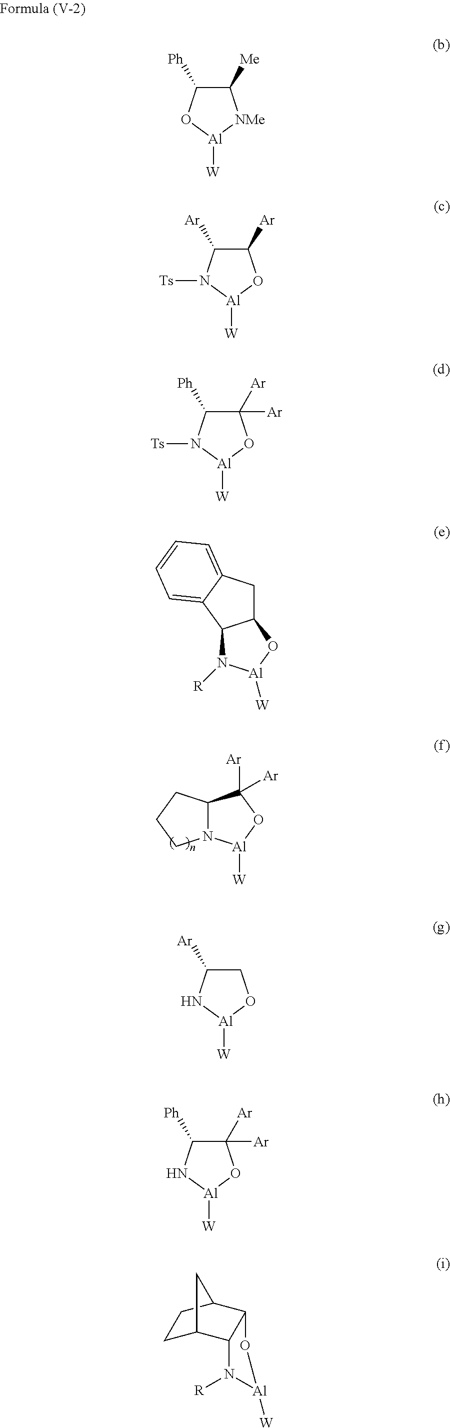

Nucleophiles for asymmetric Strecker reaction, the nucleophiles include Strecker nucleophiles that are derived from chiral and achiral hydroxy carboxylic acids and amino acids, having the structure of one of formula (VI):

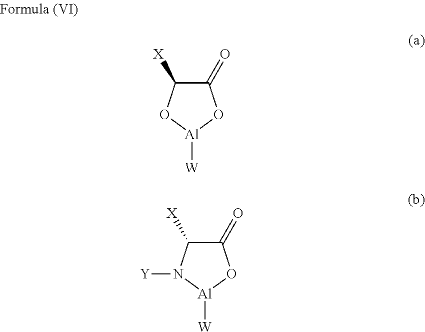

wherein (a) can be their enantiomers; and achiral ones where X═H, or, two same X groups are attached on alpha position; X=alkyl, aryl; W═CN, N₃, I;
(b) can be their enantiomers; and achiral ones where X═H, or two same X groups are attached on alpha position; X=Alkyl, aryl; Y=Alkyl, Aryl, XSO2-; W═CN, N₃, I, C≡C—Ar; C≡C—R, C≡C—CH-acetyl, X═H, alkyl, ArSO2-, ROCO— and RCO—; Beta hydroxy carboxylic acid- and beta amino acid-derived series are also covered.

(b) of formula (VI) having the structure of one of formula (VI-2)

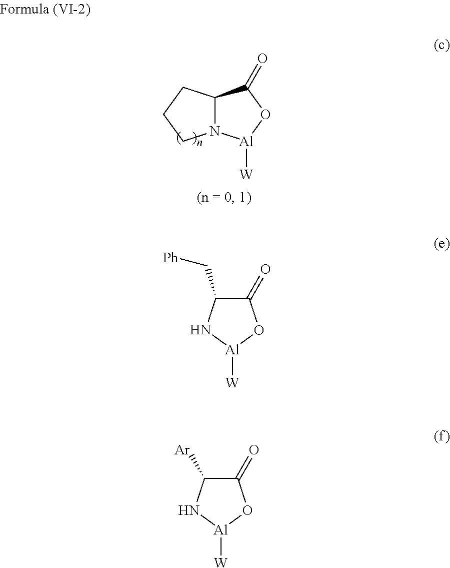

A method of forming the electrophile for asymmetric Strecker reaction, the method comprise the reaction with steps of: a) synthesizing phosphoryl chloride from achiral diamine; b) synthesizing phosphorous azide; c) synthesizing phosphoramide; d) synthesizing the corresponding achiral N-phosphonyl imines

The method comprise the reaction with steps scheme 1:

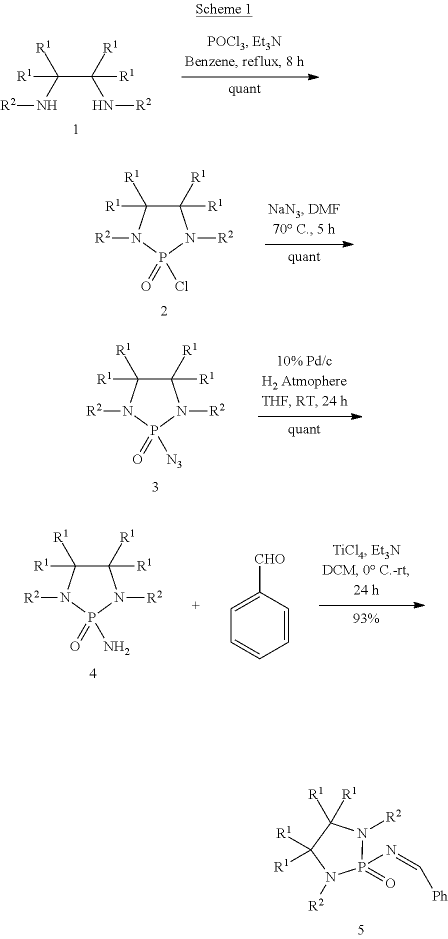

A method of forming the nucleophile for asymmetric Strecker reaction, comprise the reaction for synthesis of N-phosphoryl azides, amides and imines of scheme 2:

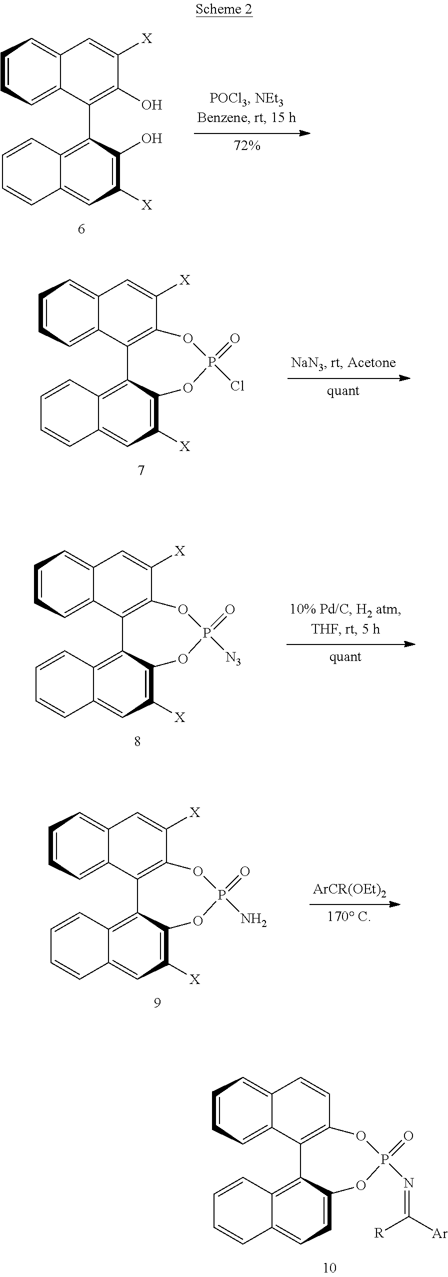

The method comprising synthesis of (S)-1,1′-Binaphthyl-2,2′-diylphosphoramide.

A improved asymmetric catalytic and/or stoichiometric Strecker process using the imines of one of the above, comprises the reaction of scheme 3:

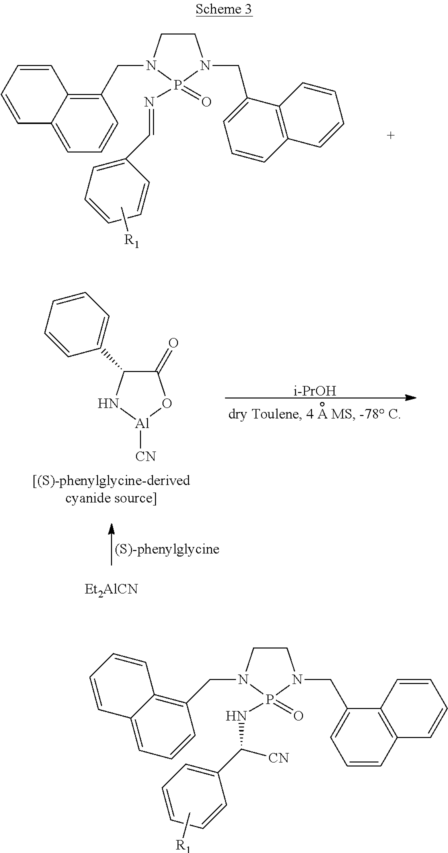

The Strecker process comprising synthesis of N-phosphonyl substituted chiral α-aminonitriles.

The Strecker process using situ generation and isolation of the Al-complexes of one of the above.

The Strecker process using diol/bionol- and amino alcohol-based systems and the reaction of diols and binols with Et₂Al—CN cannot occur below 0° C.

The advantages of the application are: new Strecker reagents of imine electrophiles and cyanide nucleophiles have been designed and synthesized. New asymmetric Strecker reaction systems have been established. The imine electrophiles include achiral N-phosphonyl imines, chiral N-phosphoryl imines and derivatives, achiral and chiral oxophospholane and oxophosphepine as well as their azide and amide precursors. The cyanide nucleophiles include chiral and achiral 1,2-diamine-derived Al-carbonitriles, diol- and BINOL-derived-Al-carbonitriles and their derivatives generated by reacting diethyl aluminum cyanide with amino acids and amino alcohols in situ or by isolation. The asymmetric catalytic Strecker reaction of new achiral N-phosphonyl imines has been developed to give excellent enantioselectivity (up to >99% ee) and yields (up to >97%). The Strecker reactions were achieved by using free amino acids, amino alcohols and BIONOLs as catalysts and by using Et₂AlCN as nucleophile which is non-toxic and inexpensive. The N—CH₂-naphthyl protection group resulted in simple purification of products by washing the crude products with hexane. This protection group can be readily cleaved under mild condition to give a quantitative recovery of N,N-bis(naphthalen-1-ylmethyl)ethane-1,2-diamine.

### DETAILED DESCRIPTION OF THE INVENTION

Formula (I) shows the structures of N-phosphorazides, N-phosphoramides, N-phosphonyl imines, oxophospholanes and their derivatives.

In Formula (I), Z═N or CH. R¹═H; C1-C20 alkyl, such as i-Pr, Me, Et, Pr, 2-Bu; Aryl; CH₂-Aryl (e.g., Bn); two R¹ groups can be cyclized.

R²=Aryl groups such as 1-Naph-, 2-Naph, 4-Me-Ph, 2-Me-Ph; C1-C20 alkyl such as i-Pr, Me, Et, Pr, 2-Bu; Aryl; CH₂-Aryl (e.g., Bn); Ts, Bs, Ms and C1-C20-R—SO2-, Ar—SO2-.
R³=Alkyl such as such as i-Pr, Me, Et, Pr, 2-Bu; Aryl groups such as Ph, 1-Naph-, 2-Naph, 4-Me-Ph, 2-Me-Ph, 4-Cl-Ph, 2-Cl-Ph, 4-Br-Ph, 2-Br-Ph, 4-Br-Ph, 2-Br-Ph, 4-I-Ph, 2-I-Ph, 4-F-Ph, 2-F-Ph, 4-MeO-Ph, 2-MeO-Ph, 4-BnO-Ph, 2-BnO-Ph, 4-AcO-Ph, 2-AcO-Ph, 2-thienyl, etc.;

One of the two nitrogens on the rings can be replaced with oxygen (from amino alcohols).

Two R²-attached nitrogens can be replaced by chiral carbons (H—C*—R²); Five-membered ring can be four- and six-membered rings with two chiral carbon centers directly attached onto phosphorus. These derivatives include (2S,5S) or (2R,5R) individual enantiomers of a-f:
a. 1-Oxo-2,5-trans-diaryl-N-(arylmethylene)phospholan-1-amine, 1-oxo-2,5-trans-diaryl-N-(alkylmethylene)phospholan-1-amine, 1-oxo-2,5-trans-dialkyl-N-(arylmethylene)phospholan-1-amine, 1-oxo-2,5-trans-dialkyl-N-(alkylmethylene)phospholan-1-amine;
b. 1-Oxo-2,5-trans-diaryl-N-(arylmethylene)-2,3-dihydro-1H-isophosphindol-1-amine, 1-oxo-2,5-trans-diaryl-N-(alkylmethylene)-2,3-dihydro-1H-isophosphindol-1-amine, 1-oxo-2,5-trans-dialkyl-N-(arylmethylene)-2,3-dihydro-1H-isophosphindol-1-amine, 1-oxo-2,5-trans-dialkyl-N-(alkylmethylene)-2,3-dihydro-1H-isophosphindol-1-amine (these imines are indeed derived from 2,5-trans-dialkyl (or diaryl)-2-amino-2-oxo-2,3-dihydro-1H-isophosphindole in which ArCH═N— or RCH═N— substitutes NH₂—);
c. 1-Oxo-2,6-trans-diaryl-N-(arylmethylene)phosphinan-1-amine, 1-oxo-2,6-t trans rans-diaryl-N-(alkylmethylene)phosphinan-1-amine, 1-oxo-2,6-trans-dialkyl-N-(arylmethylene)phosphinan-1-amine, 1-oxo-2,6-trans-dialkyl-N-(alkylmethylene)phosphinan-1-amine;
d. 1-Oxo-2,6-trans-diaryl-N-(arylmethylene)-1,4-oxaphosphinan-1-amine, 1-oxo-2,6-trans-diaryl-N-(alkylmethylene)-1,4-oxaphosphinan-1-amine, 1-oxo-2,6-trans-dialkyl-N-(arylmethylene)-1,4-oxaphosphinan-1-amine, 1-oxo-2,6-trans-dialkyl-N-(alkylmethylene)-1,4-oxaphosphinan-1-amine;
e. 1-Oxo-2,6-trans-diaryl-N-(arylmethylene)-2,3-dihydro-1H-phosphenalen-1-amine, 1-oxo-2,6-trans-diaryl-N-(alkylmethylene)-2,3-dihydro-1H-phosphenalen-1-amine, 1-oxo-2,6-trans-dialkyl-N-(arylmethylene)-2,3-dihydro-H-phosphenalen-1-amine, 1-oxo-2,6-trans-dialkyl-N-(alkylmethylene)-2,3-dihydro-1H-phosphenalen-1-amine
f. Chiral acyclic phosphines such as 1-oxo-N-(arylmethylene)-bis(1′-phenylethyl)-phosphin-1-amine.

Two R²-attached nitrogens can also be replaced by achiral carbons (CH₂), i.e., 2,5- or 2,6-alkyl/aryl groups of the above a-f are replaced by hydrogen.

“P═O” can be “P═S” for all above structures.

Formula (II) shows the structures of BINOL-derived azides, amides, imines and derivatives.

Formula (III) shows the structures of diol-based Strecker reagents and derivatives.

Formula (IV) shows the structures of diamine-based Strecker reagents and derivatives.

Formula (V) shows the structures of amino alcohol-based Strecker reagents and derivatives.

Formula (VI) shows the structures of hydroxy carboxylic acid- and amino acid-based Strecker reagents and derivatives.

### Method of Making

In the some embodiments, the method provides the synthesis of achiral N-phosphorazides, N-phosphoramides and N-phosphonyl imines and their thio derivatives as shown in Formula (I). In the structures of Formula (I), R¹, R² and R³ can be any independent organic groups. In the some embodiments, the method is directed to make the compounds as shown in Formula (I).

The Method Described Herein is Exemplified in Example 1

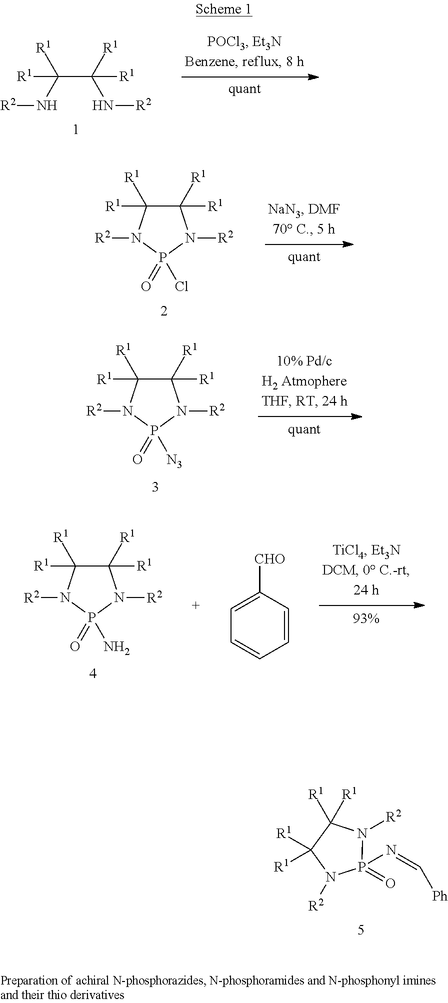

### Example 1

General procedure for yielding achiral phosphoramides is similar to the synthesis of chiral phosphoramides (Scheme 1). Achiral diamine 1 in dichloromenthane (DCM) on treatment with phosphorous oxychloride in the presence of triethylamine produced phosphoryl chloride 2; the addition was carried out at 0° C. and slowly brought to room temperature while stirring for 24 hrs. The yield was not found to be quantitative. However, when the reactants were added in benzene at room temperature and refluxed for 8 hrs, the yield was found to be quantitative. Nucleophilic substitution reaction of phosphoryl chloride 2 with sodium azide produced the corresponding phosphorous azide 3.

The reduction of phosphorous azide 3 to phosphoramide 4 was achieved using catalytic hydrogenation. The achiral phosphoramide 4 having N-isopropyl group was obtained with an excellent overall yield of 100%. These reactions proceeded very smoothly with no measurable impurities observed in any of the reactions. After successfully synthesizing achiral phosphoramides having different alkyl groups, they were used to synthesize the corresponding achiral N-phosphonyl imines having general structure 5 (step 4 in Scheme 1).

For the synthesis of oxophospholanes, (S,S) or (R,R)-2,5-diaryl-1-oxo-1-chlorophospholanes and (S,S) or (R,R)-2,5-dialkyl-1-oxo-1-chlorophospholanes are prepared first by following literature procedure (Fox, M., E.; Jackson, M.; Lennon, I. C.; Klosin, J., Abboud, K. A. J. Org. Chem., 2008, 73, 775-784). Following steps are similar to those described in Scheme 1 or by direct treatment with ammonia at chlorine substitution step. For binaphthyl-based oxophospholanes, (S) or (R)-4-chloro-4.5-dihydro-3H-4-phosphacyclohepta[2,1-a:3.4-a′]binaphthalene and its derivatives are prepared first (Hagemann, B.; Junge, K.; Enthaler, S.; Michalik, M.; Riermeier, T.; Monsees, A.; Beller, M., Adv. Synth & Cat. 2005, 347, 1978-1986; Junge, K.; Hagemann, B.; Enthaler, S.; Spannenberg, A.; Michalik, M.; Oehme, G.; Monsees, A.; Riermeier, T.; Beller, M., Tetrahedron: Asymmetry 2004, 15, 2621-2631) followed by oxidation, the above replacement steps and reduction. During this prepapration, PCl₃ can be replaced by P(═O)Cl₃ to directly generate phosphonyl chloride precursors for replacements.

### General Methods

All commercially available solvents, unless noted otherwise, were used without purification. THF was distilled from sodium/benzophenone ketyl. All the glassware used was dried overnight at 100° C. All the melting points are uncorrected. The NMR spectra were recorded at 500, 125, 202 MHz for ¹H, ¹³C and ³¹P respectively. Shifts are reported in ppm based on an internal TMS standard (for ¹H/CDCl₃) or on residual solvent peaks (for ¹³C/CDCl₃). ³¹P NMR spectra were referenced to external H₃PO₄ (0.00 ppm).

### General Procedure for the Synthesis of Achiral Phosphorus Azides (3)

In a 100 mL round-bottom flask equipped with a calcium chloride drying tube, 1.5 g of 2 (6.7 mmol) and 15 mL of N,N-dimethylformamide were mixed. To this mixture, at room temperature, 0.89 g of sodium azide (13.35 mmol) was added. The reaction was heated to 80° C. for 5 hrs. After cooling to room temperature, 20 mL of cold water was added to the reaction flask and transferred to a separatory funnel. The aqueous layer was extracted with ethyl acetate (3×50 mL), and the combined organic layers were washed with water and dried with anhydrous sodium sulfate. Sodium sulfate was filtered and evaporation of the solvent yielded phosphorazide. Compound 3a. Yellow color liquid; yield (97%); ¹H NMR (300 MHz, CDCl₃) δ 3.50-3.39 (m, 2H), 3.15-3.07 (m, 2H), 3.02-2.96 (m, 2H), 1.12 (t, J=6.0 Hz 12H), ³¹P NMR (202 MHz; CDCl₃) δ 18.2. Compound 3b. Yellow color oil; yield (95%); ¹H NMR (300 MHz, CDCl₃) δ 7.36-7.18 (m, 10H), 4.20-4.10 (m, 4H), 3.02-2.82 (m, 4H); ³¹P NMR (202 MHz; CDCl₃) δ 20.9; Compound 3c. Yellow color oil; yield (97%); ¹H NMR (300 MHz, CDCl₃) δ 8.30 (d, J=8.4 Hz, 2H), 7.89 (dd, J=16.2 & 7.8 Hz, 4H), 7.68-7.45 (m, 8H), 4.78 (dd, J=14.7 & 7.8 Hz, 2H), 4.60 (dd, J=14.7 & 5.7 Hz, 2H), 3.02 (d, J=10.8 Hz, 4H); ³¹P NMR (202 MHz; CDCl₃) δ 21.5;

### General Procedure for the Synthesis of Achiral Phosphoramides (4).

Into a 50 mL round-bottomed flask, a solution of 1.1 g of 3 (4.76 mmol) in 10 mL of THF was mixed. To this mixture, 0.11 g of 10% palladium on charcoal was added and a H₂ balloon was attached. After stirring 24 h at room temperature, the reaction mixture was diluted with methylene chloride and passed through a layer of celite. The filtrate was dried with anhydrous sodium sulfate, filtered, and evaporated under vacuum yielded pure product of 4 as a white solid. Compound 4a. White solid; yield (99%); ¹H NMR (500 MHz, CDCl₃) δ 3.68-3.48 (m, 2H), 3.17-3.07 (m, 2H), 3.04-2.94 (m, 2H), 2.49 (bs, 2H), 1.22 (d, J=6.6 Hz, 6H), 1.17 (d, J=6.6 Hz, 6H); ³¹P NMR (202 MHz; CDCl₃) δ 22.3; Compound 4b. white solid; yield (100%); ¹H NMR (300 MHz, CDCl₃) δ 7.44-7.26 (m, 10H), 4.26-4.10 (m, 4H), 3.10-2.90 (m, 4H), 2.76-2.68 (d, J=4.5 Hz, 2H); ³¹P NMR (202 MHz; CDCl₃) δ 24.7; Compound 4c. white solid; yield (100%); ¹H NMR (300 MHz, CDCl₃) δ 8.40-8.26 (m, 2H), 7.92-7.78 (m, 4H), 7.63-7.42 (m, 8H), 4.75-4.56 (m, 4H), 3.08-2.88 (m, 4H), 2.84-2.76 (m, 2H); ³¹P NMR (202 MHz; CDCl₃) δ 25.3;

### General Procedure for the Synthesis of Achiral N-Phosphonyl Imines (5).

Into a dried and nitrogen flushed round-bottom flask, achiral phosphoramide 4 (0.3 g, 1.02 mmol), Benzaldehyde (1.33 mmol) and dichloromethane (3.0 mL) were loaded. The resulting mixture was protected under nitrogen and cooled to 0° C. prior to the addition of Et₃N (0.43 mL, 3.07 mmol). Into the mixture, a solution of TiCl₄ in CH₂Cl₂ (1M, 0.5 mmol) was added dropwise. The reaction was stirred at 0° C. for 30 min, and at room temperature for 48 hrs. The clear solution of the crude reaction mixture was directly transferred to silica gel (200-300 mesh) packed in a column for chromatography and eluted by mixed solvents of hexanes/EtOAc/Et₃N (90:9:1 to 60:38:2) to purify imine products. Compound 5a: white solid; yield (85%); ¹H NMR (300 MHz, CDCl₃) δ 9.04 (d, J=33.0 Hz, 1H) 7.94-7.86 (m, 1H), 7.56-7.42 (m, 3H), 7.40-7.30 (m, 1H), 3.52-3.38 (m, 2H), 3.33-3.24 (m, 2H), 3.22-3.14 (m, 2H), 1.26-1.18 (m, 6H), 1.16-1.09 (m, 6H), ³¹P NMR (202 MHz; CDCl₃) δ 24.1; Compound 5b: white solid; yield (80%); ¹H NMR (300 MHz, CDCl₃) δ 9.09 (d, J=33.3 Hz, 1H) 7.98-7.95 (m, 2H), 7.60-7.48 (m, 3H), 7.44-7.24 (m, 10H), 4.26-4.06 (m, 4H), 3.24-3.08 (m, 4H), ³¹P NMR (202 MHz; CDCl₃) δ 25.8;

In Formula (II) both individual enantiomers for each of (d)-(i) are covered; X═H, Alkyl, Aryl group, SiR₃ and SiAr₃; R=alkyl, aryl groups, functional group (such as ester, acetals)-attached alkyl and aryl groups, acetylides; two oxygens of O—P single bonds can be replaced by “N—R” (R=alkyl, aryl groups); two oxygens of O—P single bonds can be replaced “CH₂”; “P═O” can be “P═S” except for (g)-(i) in which X═H; For structure (g) X cannot be H for both P═O and P═S cases.

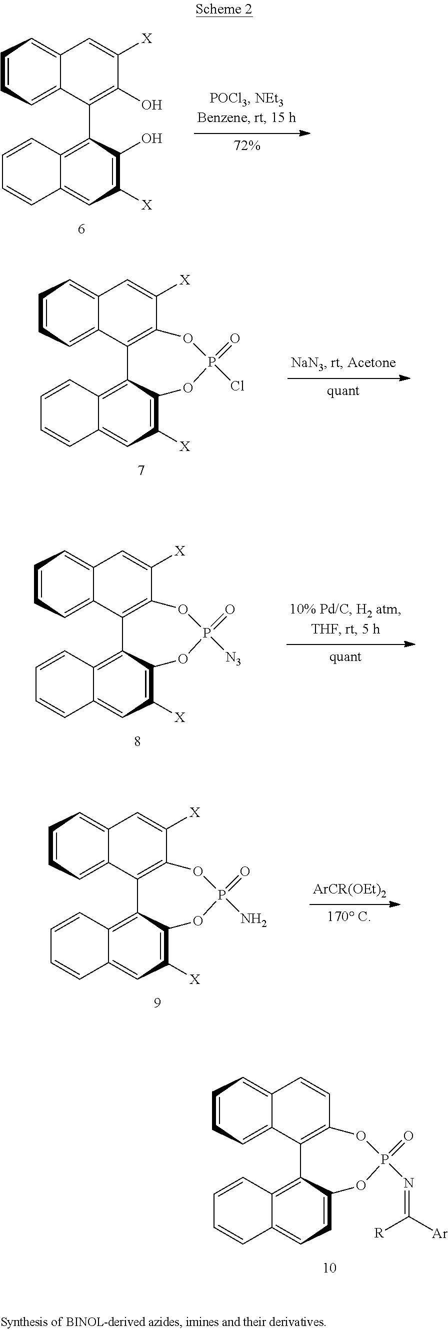

TABLE 1
Synthesis of chiral phosphoryl imines.^{a}

| Entry | Ar | R | Product | Time (min) | Mp (° C.) | Yield^{b}(%) |
|---|---|---|---|---|---|---|
| 1 | Ph | H | 10a | 12 | 117-119 | 94 |
| 2 | 4-MeC₆H₄ | H | 10b | 5 | 128-130 | 96 |
| 3 | 4-MeOC₆H₄ | H | 10c | 10 | 133-135 | 100 |
| 4 | 4-ClC₆H₄ | H | 10d | 10 | 112-114 | 85 |
| 5 | 4-FC₆H₄ | H | 10e | 10 | 120-122 | 93 |
| 6 | 2-BrC₆H₄ | H | 10f | 13 | 97-99 | 81 |
| 7 | 3-BrC₆H₄ | H | 10g | 10 | 94-96 | 84 |
| 8 | 4-BrC₆H₄ | H | 10h | 10 | 116-118 | 92 |
| 9 | Ph | Me | 10i | 20 | 118-120 | 71 |

^{a}Conditions: mixture of phosphoramide 9 (1.0 mmol) and ArCR(OEt)₂ (1.3 mmol) at 170° C.
^{b}Isolated yields after column chromatography.

### Example 2

1. Synthesis of (S)-1,1′-Binaphthyl-2,2′-diyl phosphoramide (X═H, Scheme 2): Into a solution of the phosphorus azide (5.59 g, 15 mmol) in anhydrous THF (80 mL) was added 10% palladium on charcoal (200 mg) in an round bottom flask equipped with H₂ balloon. The reaction completed in 5 hours. Filter the solution through Celite and concentrate the filtrate to get the phosphoroamide as white solid. Mp 293-295° C. ¹H NMR (CDCl₃, 300 MHz): δ 8.02-7.98 (dd, J=1.8 Hz, 8.7 Hz, 2H), 7.93 (d, J=8.1 Hz, 2H), 7.59 (d, J=9.0 Hz, 1H), 7.51 (d, J=9.0 Hz, 1H), 7.47-7.42 (m, 2H), 7.39-7.25 (m, 4H), 3.47 (d, J=7.2 Hz, 2H). ³¹P NMR (CDCl₃, 202 MHz): δ 15.92.
2. Typical procedure for the synthesis of chiral N-phosphoryl imine (X═H, Scheme 2): In a small vial, a mixture of chiral phosphoramide 9 (347 mg, 1 mmol) and benzaldehyde diethyl acetal (234 mg, 1.3 mmol) was stirred at 170° C. for 12 min, during which time the reaction mixture became liquid and ethanol was distilled off from it. After complete consumption of the phosphoramide and there was no more ethanol coming out, the mixture was purified by column chromatography to get the imine 10a. For 10a: white solid. ¹H NMR (CDCl₃, 300 MHz): δ 9.29 (d, J=33.9 Hz, 1H), 8.05 (d, J=8.7 Hz, 1H), 7.99-7.87 (m, 5H), 7.66-7.59 (m, 2H), 7.49-7.38 (m, 7H), 7.33-7.27 (m, 2H). ³¹P NMR (CDCl₃, 202 MHz): δ 15.99. For 10b: White solid. ¹H NMR (CDCl₃, 300 MHz): δ 9.24 (d, J=33.9 Hz, 1H), 8.05 (d, J=9.0 Hz, 1H), 7.98-7.91 (m, 3H), 7.77 (d, J=8.1 Hz, 2H), 7.64 (d, J=9.0 Hz, 1H), 7.49-7.38 (m, 5H), 7.32-7.25 (m, 4H), 2.42 (s, 3H). ³¹P NMR (CDCl₃, 202 MHz): δ 16.48. For 10c: White solid. ¹H NMR (CDCl₃, 300 MHz): δ 9.23 (d, J=33.9 Hz, 1H), 8.04 (d, J=9.0 Hz, 1H), 7.98-7.91 (m, 3H), 7.85-7.82 (dd, J=1.8 Hz, 6.9 Hz, 2H), 7.66-7.63 (m, 1H), 7.49-7.38 (m, 5H), 7.32-7.26 (m, 2H), 6.94 (d, J=9.0 Hz, 2H), 3.86 (s, 3H) ³¹P NMR (CDCl₃, 202 MHz): δ 16.97. For 10d: White solid. ¹H NMR (CDCl₃, 300 MHz): δ 9.24 (d, J=33.6 Hz, 1H), 8.05 (d, J=8.7 Hz, 1H), 7.99-7.92 (m, 3H), 7.83-7.80 (m, 2H), 7.65-7.62 (dd, J=0.9 Hz, 9.0 Hz, 1H), 7.51-7.38 (m, 7H), 7.33-7.30 (m, 2H). ³¹P NMR (CDCl₃, 202 MHz): δ 15.52. For 10e: White solid. ¹H NMR (CDCl₃, 300 MHz): δ 9.24 (d, J=33.6 Hz, 1H), 8.05 (d, J=8.7 Hz, 1H), 7.99-7.87 (m, 5H), 7.66-7.63 (dd, J=0.6 Hz, 8.7 Hz, 1H), 7.50-7.38 (m, 5H), 7.32-7.27 (m, 2H), 7.18-7.12 (m, 2H). ³¹P NMR (CDCl₃, 202 MHz): δ 15.74. For 10f: White solid. ¹H NMR (CDCl₃, 300 MHz): δ 9.64 (d, J=33.3 Hz, 1H), 8.09-8.05 (m, 2H), 8.00-7.89 (m, 4H), 7.68-7.61 (m, 1H), 7.50-7.37 (m, 6H), 7.35-7.27 (m, 3H). ³¹P NMR (CDCl₃, 202 MHz): δ 14.84. For 10g: White solid. ¹H NMR (CDCl₃, 300 MHz): δ 9.21 (d, J=33.6 Hz, 1H), 8.07-7.92 (m, 4H), 7.77 (d, J=7.8 Hz, 1H), 7.72-7.69 (m, 1H), 7.65-7.62 (m, 1H), 7.50-7.37 (m, 6H), 7.34-7.27 (m, 3H). ³¹P NMR (CDCl₃, 202 MHz): δ 14.99. For 10h: White solid. ¹H NMR (CDCl₃, 300 MHz): δ 9.23 (d, J=33.6 Hz, 1H), 8.05 (d, J=9.0 Hz, 1H), 7.99-7.92 (m, 3H), 7.74-7.71 (m, 2H), 7.65-7.59 (m, 3H), 7.50-7.45 (m, 2H), 7.42-7.38 (m, 3H), 7.32-7.27 (m, 2H). ³¹P NMR (CDCl₃, 202 MHz): δ 15.46. For 10i: White solid. ¹H NMR (CDCl₃, 300 MHz): δ 8.06-7.91 (m, 6H), 7.68-7.65 (dd, J=1.2 Hz, 8.7 Hz, 1H), 7.56-7.37 (m, 8H), 7.32-7.25 (m, 2H), 2.98 (d, J=2.7 Hz, 3H). ³¹P NMR (CDCl₃, 202 MHz): δ 12.98.
   About the Strecker Nucleophiles and their Derivatives

In Formula (III) (a)-(b) can be their enantiomers; X=alkyl, aryl, SiR₃ and SiAr₃; W═CN, N₃, I, C≡C—Ar; C≡C—R, C≡C—CH-acetyl. Derivatives from 1-(2-hydroxy-5,6,7,8-tetranhydronaphthalen-1-yl)-5,6,7,8-tetranhydronaphthalen-2-ol are also covered. (c) can be their enantiomers; X=Aryl, Alkyl, W═CN, N₃, I, C≡C—Ar; C≡C—R, C≡C—CH-acetyl; R=Alkyl, Aryl groups; can be different; can be cyclic, two R's are connected. (d)-(h) can be their enantiomers; and achiral ones where X═H, or, four same X groups are attached on 1,2-positions; X=Alkyl, Aryl, CR₂(—OR); W═CN, N₃, I, C≡C—Ar; C≡C—R, C≡C—CH-acetyl. In (i)-(k) X=Alkyl, Aryl, W═CN, N₃. In (l)-(q) X=Alkyl, Aryl, COOR; W═CN, N₃, I.

In Formula (IV) (a)-(b) can be their enantiomers; achiral ones where X═H, or, four identical X groups are attached on 1,2-positions; X=Aryl, Alkyl; Y=alkyl, aryl and RSO2-; W═CN, N₃, I, C≡C—Ar; C≡C—R, C≡C—CH-acetyl. (d)-(f) can be their enantiomers; X=alkyl, aryl, SiR₃ and SiAr₃; Y=alkyl, aryl. W═CN, N₃, I, C═C—Ar; C═C—R, C═C—CH-acetyl. 1,3-diamine-derived complexes are also covered.

In Formula (V) and Formula (V-2), (a)-(i) can be their enantiomers; X=Alkyl, Aryl, COOR; W═CN, N₃, I, C≡C—Ar; C≡C—CH-acetyl, R═H, alkyl, ArSO2-, ROCO— and RCO—; and achiral ones where X═H, or to same X groups are attached on alpha, beta positions. 1,3-amino alcohol-derived complexes are also covered.

In Formula (VI) (a) can be their enantiomers; and achiral ones where X═H, or, two same X groups are attached on alpha position; X=alkyl, aryl; W═CN, N₃, I. (b)-(f) can be their enantiomers; and achiral ones where X═H, or two same X groups are attached on alpha position; X=Alkyl, aryl; Y=Alkyl, Aryl, XSO2-; W═CN, N₃, I, C≡C—Ar; C≡C—R, C≡C—CH-acetyl, X═H, alkyl, ArSO2-, ROCO— and RCO—. Beta hydroxy carboxylic acid- and beta amino acid-derived series are also covered.

### Example 3

### For the Synthesis of Aluminum Complexes

The Strecker cyanide sources derived from hydroxy carboxylic acids, amino acids, diamines, amino alcohols and diols can be prepared by following general procedure. Into a dried and nitrogen flushed round-bottom flask, the corresponding diamine or diol (0.1 g, 0.34 mmol, and toulene (3.0 mL) were loaded. The resulting mixture was protected under nitrogen and diethyl aluminum cyanide (1 M, 0.34 mmol) was added dropwise. The reaction was stirred at room temperature for 6 h and monitored by ¹H NMR. After the reaction was completed, the solvent was dried off completely to get the product. Aluminum complex with 1,2-diphenyl amine [Formula (IV)], (a), X=Ph, Y═H, W═CN] white solid (yield 82%); ¹H NMR (300 MHz, CDCl₃) δ 7.20-7.02 (m, 10H), 3.71 (s, 2H), 2.60-2.40 (m, 2H), 0.98 (dd, J₁=6.0 Hz, J₂=12.6 Hz 12H). Aluminum complex with S-BINOL [Formula (III), (a), X═H, W═CN] off white solid (yield 86%); ¹H NMR (300 MHz, CDCl₃) δ 8.06-7.82 (dd, J₁=7.5 Hz, J₂=12.0 Hz, 2H), 7.41-7.17 (m, 10H). Aluminium complex with pinacol [Formula (III-2), (f)] off white solid (yield 87%); ¹H NMR (300 MHz, CDCl₃) δ 1.38 (s, 12H). 1,3-Propanediol-derived aluminium complex with pinacol [Formula (III), (m)] (yield 87%) ¹H NMR 6 (300 MHz, CDCl₃): 3.90-3.84 (m, 4H), 1.90 (t, J=6.0 Hz, 2H), 1.83 (t, J=4.5 Hz, 2H).

### Example 4

### For Strecker Reaction Processes

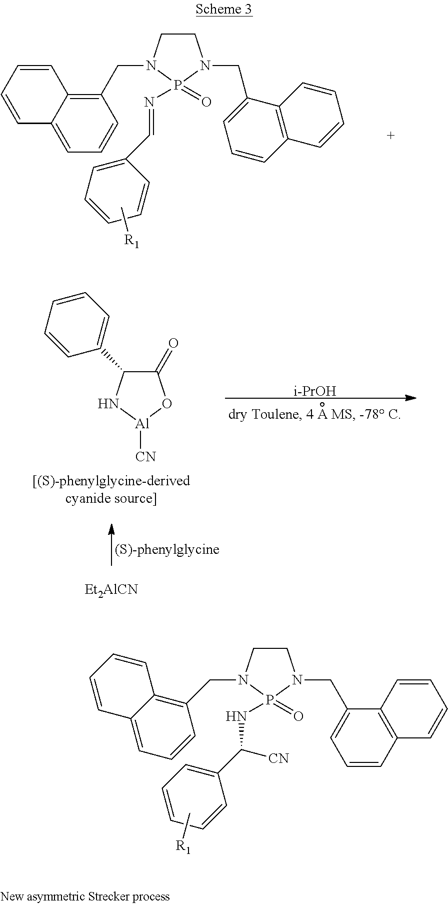

Wherein (S)-Phenylglycine-derived cyanide source above is the actual reactive nucleophilic species; chiral diamines and diols and their derivatives can replace (S)-phenylglycine for forming similar species for this asymmetric reaction.

This invention covers chiral amino acids' concentration 1 mol % to 100% (1 equiv); Strecker reactions using above imines and catalytic Strecker reactions using Et₂AlCN.

TABLE 2
Results of the synthesis of N-phosphonyl
substituted chiral α-aminonitriles 11a-k^{a}

| Entry | Substrate | R₁ | Product | Yield(%) ^{b} | ee ^{c} |
|---|---|---|---|---|---|
| 1 | 11a | H | 12a | 95 | 99.7 |
| 2 | 11b | p-fluoro | 12b | 96 | 94 |
| 3 | 11c | p-bromo | 12c | 97 | 96 |
| 4 | 11d | p-chloro | 12d | 95 | 95.2 |
| 5 | 11e | p-methyl | 12e | 94 | 98.8 |
| 6 | 11f | p-methoxy | 12f | 93 | 97.6 |
| 7 | 11g | o-fluoro | 12g | 94 | 96.1 |
| 8 | 11h | o-bromo | 12h | 92 | 97 |
| 9 | 11i | o-chloro | 12i | 90 | 95.2 |
| 10 | 11j | o-methyl | 12j | 92 | 98.9 |
| 11 | 11k | o-furyl | 12k | 89 | 99 |

^{a}All reactions were carried out at −78° C. in 0.06 M solution of imine in toluene.
^{b} Combined yields of both isomers.
^{c} Enantiomeric ratio has been determined by using chiral HPLC OD-H column (3:7 IPA:Hexane), flow rate = 0.60 ml/min.

### General Information

All commercially available solvents, unless otherwise mentioned, were used without purification. THF was distilled from sodium/benzophenone ketyl. All the glassware used was dried overnight at 100° C. All melting points are uncorrected. The NMR spectra were recorded at 500, 125, 202 MHz for ¹H, ¹³C and ³¹P respectively. Shifts are reported in ppm based on an internal TMS standard (for ¹H/CDCl₃) or on residual solvent peaks (for ¹³C/CDCl₃). ³¹P NMR spectra were referenced to external H₃PO₄ (0.00 ppm). Dry i-PrOH was obtained from Acros. Diethylaluminium cyanide (1.0 M solution in toluene) and Titanium (IV) chloride (1.0 M solution in dichloromethane) were obtained from Aldrich and used as obtained from commercial sources without any further purification. Flash chromatographic columns were carried out on silica gel 60, (230-400 mesh).

Typical Procedure for the Synthesis of Achiral N-Phosphonyl Imine (11a-k)

In a dry vial, under inert gas protection, N,N-naphthalen-1-ylmethyl phosphoramide (1.0 equiv.) was taken and dissolved in dry dichloromethane. To the solution, corresponding aldehyde (1.5 equiv.) was added followed by the addition of triethylamine (3.0 equiv.). The reaction was cooled down to 0° C. and titanium (IV) chloride (1.0 M solution in DCM, 0.5 equiv.) was added to the reaction (Scheme 1). The reaction was allowed to stir at room temperature for 36 h and after that the mixture was loaded directly to silica gel. The reaction mixture was purified through column chromatography (Ethyl acetate:Hexane: 1% Et₃N). Pure product was obtained by eluting the reaction mixture with ethyl acetate:hexane:triethylamine (60:40:1 mL) as white or pale yellow solid in all of the cases reported. Compound 11a White solid; yield (0.172 g, 76%); mp 84-86° C.; ¹H NMR (500 MHz, CDCl₃) δ 9.03 (d, J=33.5 Hz, 1H), 8.28 (d, J=9.0 Hz, 2H), 7.86-7.82 (m, 4H), 7.78 (d, J=8.0 Hz, 2H), 7.53-7.46 (m, 9H), 7.42-7.39 (m, 2H), 4.67-4.64 (m, 2H), 4.55-4.52 (m, 2H), 3.13 (d, J=9.5 Hz, 4H); ¹³C NMR (125 MHz, CDCl₃) δ 173.5 (d, J=7.0 Hz), 139.6, 135.8, 135.6 (2C), 133.7, 133.1, 132.7 (2C), 132.6, 131.7 (2C), 129.9 (2C), 128.7 (2C), 128.4, 128.3, 126.7 (2C), 126.2, 125.7, 125.4, 125.0 (2C), 123.8, 120.5, 47.43, 47.40 (d, J=7.3 Hz), 44.9, 42.3. ³¹P NMR (202 MHz, CDCl₃) δ 24.2. Compound 11b White foamy solid; Yield (0.214 g, 82%); mp 68-70° C.; ¹H NMR (500 MHz, CDCl₃) δ 8.87 (d, J=32.9 Hz, 1H), 8.24 (dd, J=8.9, 1.8 Hz, 2H), 7.83-7.76 (m, 6H), 7.52-7.46 (m, 6H), 7.41-7.38 (m, 2H), 7.15 (t, J=8.5 Hz, 2H), 4.66-4.49 (m, 4H), 3.15-3.11 (m, 4H). ¹³C NMR (125 MHz, CDCl₃) δ 172.3 (d, J=6.45 Hz), 166.8, 164.8, 133.8 (2C), 132.65 (d, J=6.94 Hz, 2C), 132.18 (d, J=8.9 Hz, 2C), 131.7 (2C), 128.5 (2C), 128.4 (2C), 126.8 (2C), 126.3 (2C), 125.8 (2C), 125.1 (2C), 123.9 (2C), 116.1, 115.9, 47.5 (d, J=4.9 Hz, 2C), 45.0 (d, J=10.4 Hz, 2C). ³¹P NMR (202 MHz, CDCl₃) δ 26.1. Compound 11c Pale yellow solid; Yield (0.355 g, 82%); mp 60-62° C. ¹H NMR (500 MHz, CDCl₃): 8.83 (d, J=33.0 Hz, 1H), 8.24 (d, J=8 Hz, 2H), 7.83 (dd, J=2.5 Hz, 7.5 Hz, 2H), 7.77 (d, J=8.0 Hz, 2H), 7.62 (d, J=11 Hz, 2H), 7.51-7.47 (m, 8H), 7.41-7.38 (m, 2H), 4.64 (dd, J=7.5 Hz, 15.0 Hz, 2H), 4.52 (dd, J=5.5 Hz, 15.0 Hz, 2H), 3.13 (d, J=9.0 Hz, 4H); ¹³C NMR (125 MHz, CDCl₃): 172.3 (d, J=6.9 Hz); 134.6, 134.4, 133.7 (2C), 132.5 (d, J=6.9 Hz, 2C), 132.0 (2C), 131.7 (2C), 131.5, 131.1 (2C), 128.4 (d, J=7.5 Hz, 2C), 127.9, 126.8 (2C), 126.3 (2C), 125.7 (2C), 125.1 (2C), 123.8 (2C), 47.4 (d, J=4.5 Hz, 2C), 45.0 (d, J=10.9 Hz, 2C); ³¹P NMR (202 MHz, CDCl₃): 26.0. Compound 11d White foamy solid; Yield (0.186 g, 87%); mp 60-62° C.; ¹H NMR (500 MHz, CDCl₃) δ 8.84 (d, J=33.0 Hz, 1H), 8.25-8.22 (m, 2H), 7.84-7.69 (m, 6H), 7.52-7.37 (m, 10H), 4.68-4.48 (m, 4H), 3.15-2.89 (m, 4H). ¹³C NMR (125 MHz, CDCl₃) δ 172.5 (d, J=6.6 Hz), 139.5, 134.6, 134.2, 134.0 (2C), 132.8 (d, J=6.9 Hz), 131.9 (2C), 131.3 (2C), 129.3 (2C), 128.7 (2C), 128.7 (2C), 127.1 (2C), 126.5 (2C), 126.0 (2C), 125.3 (2C), 124.0 (2C), 47.6 (d, J=4.9 Hz, 2C), 45.2 (d, J=10.9 Hz, 2C). ³¹P NMR (202 MHz, CDCl₃) δ 26.0.

Compound 11e White solid; Yield (0.208 g, 87%); mp 64-66° C.; ¹H NMR (500 MHz, CDCl₃) δ 9.33 (d, J=33.3 Hz, 1H), 8.27 (d, J=8.5 Hz, 2H), 8.02 (d, J=8.0 Hz, 1H), 7.83 (d, J=8.0 Hz, 2H), 7.78 (d, J=8.5 Hz, 2H), 7.53-7.39 (m, 9H), 7.31 (t, J=7.5 Hz, 1H), 7.23 (d, J=8.0 Hz, 1H), 4.66 (d, J=7.0 Hz, 2H), 4.55 (d, J=5.0 Hz, 2H), 3.13 (d, J=10.0 Hz, 4H), 2.49 (s, 3H). ¹³C NMR (125 MHz, CDCl₃) δ 172.5 (d, J=12.5 Hz), 140.6 (2C), 133.7 (2C), 132.8 (d, J=7.4 Hz), 132.6 (2C), 131.7, 131.2 (2C), 129.3 (2C), 128.4 (2C), 128.3 (2C), 126.5 (2C), 126.3 (2C), 126.1, 125.7 (2C), 125.1 (2C), 123.8 (2C), 47.5 (d, J=4.7 Hz, 2C), 45.0 (d, J=10.6 Hz, 2C), 19.4. ³¹P NMR (202 MHz, CDCl₃) δ 26.4. Compound 11f White solid, yield (0.198 g, 87%); mp 64-66° C.; ¹H NMR (500 MHz, CDCl₃) δ 8.98 (d, J=33.3 Hz, 1H), 8.31 (d, J=8.4 Hz, 2H), 7.88-7.79 (m, 6H), 7.57-7.41 (m, 8H), 7.02 (d, J=8.7 Hz, 2H), 4.71-4.53 (m, 4H), 3.92 (s, 3H), 3.13 (d, J=9.6 Hz, 4H). ¹³C NMR (125 MHz, CDCl₃) δ 173.4 (d, J=6.52 Hz), 164.1 (2C), 134.1 (2C), 133.16 (d, J=7.4 Hz, 2C), 132.4 (2C), 132.1 (2C), 128.7 (2C), 128.6 (2C), 127.0 (2C), 126.6 (2C), 126.0 (2C), 125.4 (2C), 124.2 (2C), 114.4 (2C), 55.8, 47.8 (d, J=4.7 Hz, 2C), 45.3 (d, J=10.6 Hz, 2C). ³¹P NMR (202 MHz, CDCl₃) δ 26.8. Compound 11g White solid, Yield (0.214 g, 81%); mp 64-66° C.; ¹H NMR (500 MHz, CDCl₃) δ 9.30 (d, J=33.0 Hz, 1H), 8.32-8.25 (m, 2H), 8.12-8.07 (m, 1H), 7.88-7.56 (m, 5H), 7.59-7.38 (m, 10H), 4.72-4.49 (m, 4H), 3.13-2.92 (m, 4H). ³¹P NMR (202 MHz, CDCl₃) δ 26.3. The imine started decomposing before the 13-C NMR could be recorded. Compound 11h Pale yellow solid; Yield (0.362 g, 79%); mp 54-56° C. ¹H NMR (500 MHz, CDCl₃) δ 9.32 (d, J=32.5 Hz, 1H), 8.27 (d, J=8.5 Hz, 2H), 8.15-8.13 (m, 1H), 7.83 (d, J=8.25 Hz, 2H), 7.77 (d, J=8.0 Hz, 2H), 7.62-7.60 (m, 1H), 7.54-7.44 (m, 6H), 7.42-7.36 (m, 4H), 4.71 (dd, J=7.0 Hz, 15.0 Hz, 2H), 4.56 (dd, J=5.0 Hz, 14.5 Hz, 2H), 3.12 (d, J=10.0 Hz, 4H); ¹³C NMR (125 MHz, CDCl₃) δ 171.4 (d, J=5.4 Hz), 134.23, 133.9, 133.8, 133.4, 132.6 (d, J=7.0 Hz, 2C), 131.7 (2C), 129.6, (2C), 128.4 (d, 11.2 Hz, 2C), 127.6 (2C), 127.5 (2C), 126.6 (2C), 126.4 (2C), 125.8 (2C), 125.1 (2C), 123.8 (2C), 47.5 (d, J=4.5 Hz, 2C), 44.9 (d, J=10.7 Hz, 2C); ³¹P NMR (202 MHz, CDCl₃) δ 26.0. Compound 11i White foamy solid, Yield (0.225 g, 85%); mp 66-68° C.; ¹H NMR (500 MHz, CDCl₃) δ 9.39 (d, J=32.7 Hz, 1H), 8.43-8.14 (m, 2H), 7.88-7.75 (m, 5H), 7.58-7.29 (m, 11H), 4.74-4.52 (m, 4H), 3.14-2.85 (m, 4H). ¹³C NMR (125 MHz, CDCl₃) δ 167.0 (d, J=5.7 Hz), 135.1 (d, J=8.9 Hz), 134.0 (2C), 132.8 (d, J=6.8 Hz), 131.9 (2C), 128.8, 128.7 (2C), 128.6 (2C), 128.5 (2C), 126.9 (2C), 126.5 (2C), 126.5, 126.0 (2C), 125.4, 125.3 (2C), 124.6, 124.0 (2C), 123.9, 116.4, 47.6 (d, J=4.8 Hz, 2C), 45.1 (d, J=10.9 Hz, 2C). ³¹P NMR (202 MHz, CDCl₃) δ 26.2. Compound 11j Pale yellow solid; Yield (0.284 g, 82%); mp 62-64° C. ¹H NMR (500 MHz, CDCl₃): 9.62 (d, J=33.5 Hz, 1H), 8.29 (d, J=8.0 Hz, 2H), 7.82-7.76 (m, 6H), 7.53-7.38 (m, 10H), 4.69 (dd, J=7.0 Hz, 15.0 Hz, 2H), 4.54 (dd, J=5.0 Hz, 14.5 Hz, 2H), 3.08 (d, J=10.0 Hz, 4H), 2.04 (s, 3H); ¹³C NMR (125 MHz, CDCl₃): 169.8 (d, J=5.4 Hz), 134.7 (2C), 133.6 (2C), 132.8 (d, J=7.3 Hz, 2C), 131.6 (2C), 128.3 (2C), 128.2 (2C), 128.0 (2C), 126.4, (2C), 126.2 (2C), 125.8 (2C), 125.1 (2C), 123.8 (2C), 120.4, 111.1, 47.3 (d, J=4.5 Hz, 2C), 44.8 (d, J=10.7, 2C), 14.0; ³¹P NMR (202 MHz, CDCl₃): 25.8. Compound 11k Yellow color solid; Yield (0.216 g, 90%), mp 68-70° C.; ¹H NMR (500 MHz, CDCl₃) δ 8.85 (d, J=34.2 Hz, 1H), 8.29 (d, J=7.8 Hz, 2H), 7.86-67.78 (m, 4H), δ7.71 (s, 1H), 7.57-7.41 (m, 8H), 7.07 (d, J=3.6 Hz, 1H), 6.62-6.61 (m, 1H), 4.71-4.64 (m, 2H), 4.56-4.49 (m, 2H), 3.22-3.09 (m, 4H). ¹³C NMR (125 MHz, CDCl₃) δ161.2 (d, J=5.9 Hz), 152.1, 151.8, 147.4, 133.7 (2C), 132.6 (d, J=7.3 Hz), 131.7 (2C), 128.4 (d, J=13.7 Hz, 2C), 126.7 (2C), 126.3 (2C), 125.7 (2C), 125.1 (2C), 123.8 (2C), 121.2 (2C), 112.7 (2C), 47.2 (d, J=5.0 Hz, 2C), 44.8 (d, J=10.3 Hz, 2C). ³¹P NMR (202 MHz; CDCl₃) δ 26.4.

### Typical Procedure for the Synthesis of N-Phosphonyl Substituted α-Aminonitrile

In a dry vial, under inert gas protection, 4 A MS and the chiral amino acid was loaded followed by the addition of dry toluene. A turbid solution was obtained in which diethylaluminium cyanide (1.0 M solution in toluene, 1.50 equiv.) was added followed by the addition of i-PrOH (1.0 equiv.). The solution slowly became clear on stirring at room temperature for 15 min. After 15 min, the reaction was brought to −78° C. and stirred for 30 min followed by the addition of achiral N-phosphonyl imine (1.0 equiv.) pre-dissolved in 3 mL of toluene. The reaction mixture was constantly monitored by TLC and allowed to stir for 5 h before it was quenched by adding 0.05 M hydrochloric acid followed by the addition of 10 mL ethylacetate and 10 mL water. The solution was filtered off through celite and organic layer was separated and dried over anhydrous sodium sulfate. Sodium sulfate was filtered off and the organic layer was evaporated to obtain the desired product as pale yellow solid which on washing with hexanes afforded the pure product as white solid without any further purification in all the cases reported. Compound 12a White solid; yield (0.246 g, 92%); mp 112-114° C.; [α]_{D}²⁴=+2.52 (c 1.0, CHCl₃) ¹H NMR (500 MHz, CDCl₃) δ 8.22 (d, J=9.5 Hz, 2H), 8.15 (d, J=7.5 Hz, 2H), 7.86 (t, J=7.0 Hz, 2H), 7.80 (d, J=8.0 Hz, 2H), 7.51-7.45 (m, 5H), 7.44-7.39 (m, 4H), 7.35-7.34 (m, 2H), 5.42 (t, J=9.0 Hz, 1H), 4.65-4.55 (m, 4H), 3.44 (t, J=9.5 Hz, 1H), 3.05-3.01 (m, 4H). ¹³C NMR (125 MHz, CDCl₃) δ 135.36, 135.31, 133.8, 133.7, 132.37, 132.31, 131.6 (d, J=8.0 Hz, 2C), 128.6 (d, J=7.3 Hz, 2C), 128.5, 128.4, 128.3, 126.7, 126.6, 126.5, 126.4, 126.3, 125.9, 125.8, 125.24, 125.20, 123.4, 123.3 (2C), 119.98, 119.92, 47.5, 46.8 (d, J=7.3 Hz), 44.6 (d, J=7.8 Hz), 44.0, 43.9. ³¹P NMR (202 MHz, CDCl₃) δ 21.9. HRMS (ESI): m/z calcd for C₃₂H₃₀N₄OP, 517.2152. Found, 517.2156. Ee: 99.7% (retention time=6.77 (major), flow rate=0.60 ml/min, OD-H chiral column (7:3 hexane:IPA solvent system). Compound 12b Off-white solid, Yield (0.172 g, 96%); mp: 126-128° C., [α]_{D}²⁴=+7.0 (c 0.8, CHCl₃); ¹H NMR (500 MHz, CDCl₃) δ 8.16 (dd, J=9.2, 27.2 Hz, 2H), 7.82 (dd, J=8.0, 36.0 Hz, 4H), 7.51-7.44 (m, 6H), 7.40 (q, J=8.2 Hz, 2H), 7.33 (q, J=5.1 Hz, 2H), 6.95 (t, J=8.5 Hz, 2H), 5.36 (t, J=9.0 Hz, 1H), 4.67-4.52 (m, 4H), 3.82 (q, J=9.8 Hz, 1H, NH), 3.12-3.02 (m, 4H). ¹³C NMR (125 MHz, CDCl₃) δ 163.9, 161.9, 133.8 (d, J=8.9 Hz, 2C), 132.3 (d, J=2.5 Hz), 132.2, 131.5 (d, J=9.9 Hz), 131.2, 128.7 (d, J=6.9 Hz, 2C), 128.6 (2C), 128.5, 128.4, 126.7, 126.4 (d, J=12.4 Hz, 2C), 126.3, 125.9 (d, J=9.9 Hz, 2C), 125.2 (d, J=3.9 Hz, 2C), 123.3 (d, J=12.9 Hz, 2C), 119.7 (d, J=3.5 Hz), 116.14 (d, J=21.8 Hz, 2C), 46.84 (d, J=3.9 Hz), 46.82, 46.1 (d, J=4.9 Hz), 44.8 (d, J=12.4 Hz), 44.0 (d, J=13.4 Hz). ³¹P NMR (202 MHz, CDCl₃) δ 22.1. HRMS (ESI): m/z calcd for C₃₂H₂₈FN₄OPNa, 557.1877. Found, 557.1884. Ee: 94% (retention time=6.49 (minor) and 7.17 (major), flow rate=0.60 ml/min, OD-H chiral column (7:3 hexane:IPA solvent system). Compound 12c White solid; Yield (0.135 g, 97%); mp 138-140° C.; [α]_{D}²⁵=+8.0° (c 0.6, CHCl₃). ¹H NMR (500 MHz, CDCl₃): 8.14 (dd, J=7.5 Hz, 16.5 Hz, 2H), 7.86 (d, J=7.5 Hz, 2H), 7.79 (d, J=8.0 Hz, 2H), 7.51-7.45 (m, 6H), 7.43-7.36 (m, 4H), 7.20 (d, J=8.0 Hz, 2H), 5.32 (t, J=9.0 Hz, 1H), 4.66-4.49 (m, 4H), 3.90 (q, J=6.5 Hz, 1H), 3.11-3.05 (m, 4H); ¹³C NMR (125 MHz, CDCl₃): 134.4 (d, J=5.9 Hz), 133.8 (d, J=7.9 Hz), 132.3 (2C), 132.2, 131.6 (d, J=8.4 Hz), 128.7 (d, J=3.5 Hz, 2C), 128.5 (2C), 128.4 (2C), 128.3 (2C), 126.6 (2C), 126.4 (d, J=7.9 Hz, 2C), 126.2 (2C), 125.9 (d, J=7.5 Hz, 2C), 125.2 (d, J=2.9 Hz, 2C), 123.4, 123.3 (d, J=12.8 Hz), 119.5 (d, J=3.5 Hz), 46.9, 46.8 (d, J=4.4 Hz), 46.1 (d, J=4.9 Hz), 44.8 (d, J=12.2 Hz), 44.1 (d, J=13.4 Hz); ³¹P NMR (202 MHz, CDCl₃): 23.0. HRMS (ESI): m/z calcd for C32H29BrN4OP, 595.1257. Found, 595.1262. Ee: 96% (retention time=6.41 (minor) and 6.84 (major), flow rate=0.60 ml/min, OD-H chiral column (7:3 hexane:IPA solvent system). Compound 12d Pale yellow color solid, Yield (0.128 g, 95%); mp 134-136° C., [α]_{D}²⁴=+8.60 (c 0.6, CHCl₃); ¹H NMR (500 MHz, CDCl₃) 8.15 (dd, J=8.3, 23.4 Hz, 2H), 7.86 (d, J=7.8 Hz, 2H), 7.78 (d, J=8.1 Hz, 2H), 7.51-7.45 (m, 6H), 7.40 (q, J=7.8 Hz, 2H), 7.28-7.22 (m, 4H), 5.35 (t, J=9.0 Hz, 1H), 4.66-4.51 (m, 4H), 3.77 (bs, 1H, NH), 3.12-3.03 (m, 4H). ¹³C NMR (125 MHz, CDCl₃) δ 135.2, 133.85, 133.81, 133.7, 132.27, 132.25, 132.21, 131.5 (d, J=9.9 Hz), 129.3 (2C), 128.7 (d, J=4.9 Hz, 2C), 128.5 (d, J=17.9 Hz, 2C), 127.9 (2C), 126.7, 126.4 (d, J=9.9 Hz, 2C), 126.3, 125.9 (d, J=8.4 Hz, 2C), 125.3 (d, J=2.9 Hz, 2C), 123.2 (d, J=14.4 Hz, 2C), 119.5 (d, J=3.5 Hz), 46.9, 46.8 (d, J=4.5 Hz), 46.1 (d, J=5.4 Hz), 44.8 (d, J=11.9 Hz), 44.1 (d, J=13.4 Hz). ³¹P NMR (202 MHz, CDCl₃) δ 22.6. HRMS (ESI): m/z calcd for C32H29ClN4OP, 551.1761. Found, 551.1768. Ee: 95.2% (retention time=6.27 (minor) and 6.72 (major b flow rate=0.60 ml/min, OD-H chiral column (7:3 hexane: IPA solvent system). Compound 12e White solid, Yield (0.110 g, 94%); mp 176-178° C., [α]_{D}²⁴=+7.45 (c 0.7, CHCl₃); ¹H NMR (500 MHz, CDCl₃) δ 8.20 (d, J=7.0 Hz, 1H), 8.15 (d, J=7.5 Hz, 1H), 7.87-7.85 (m, 2H), 7.79 (d, J=5.0 Hz, 1H), 7.31 (d, J=7.0 Hz, 7H), 7.12 (d, J=7.0 Hz, 6H), 5.37 (t, J=8.5 Hz, 1H), 4.66-4.48 (m, 4H), 3.67 (t, J=10.0 Hz, 1H, NH), 3.07-2.99 (m, 4H), 2.30 (s, 3H). ¹³C NMR (125 MHz, CDCl₃) δ 139.2, 133.7 (d, J=8.4 Hz), 132.5 (d, J=6.5 Hz), 132.4 (d, J=5.5 Hz), 132.3 (d, J=6.0 Hz), 131.6 (d, J=8.4 Hz), 129.8 (2C), 128.6 (2C), 128.5 (2C), 128.4 (2C), 128.3, 126.5 (2C), 126.4 (d, J=6.4 Hz), 126.3, 125.8 (2C), 125.7 (2C), 125.2 (d, J=4.0 Hz), 123.3 (d, J=7.5 Hz), 120.0 (d, J=4.0 Hz), 47.2, 46.6 (d, J=4.5 Hz), 46.1 (d, J=5.4 Hz), 44.6 (d, J=11.9 Hz), 44.0 (d, J=12.9 Hz), 21.0. ³¹P NMR (202 MHz, CDCl₃) δ 22.5. HRMS (ESI): m/z calcd for C₃₃H₃₁N₄O₂PNa, 569.2077. Found, 569.2070. Ee: 98.8% (retention time=6.82 (major), flow rate=0.60 ml/min, OD-H chiral column (7:3 hexane:IPA solvent system). Compound 12f White solid, Yield (0.132 g, 93%); mp 182-184° C., [α]_{D}²⁴=+1.45 (c 1.1, CHCl₃); ¹H NMR (500 MHz, CDCl₃) δ 8.23-8.19 (m, 1H), 8.16-8.14 (m, 1H), 7.89-7.84 (m, 2H), 7.80-7.78 (m, 2H), 7.52-7.47 (m, 6H), 7.43-7.39 (m, 2H), 7.32-7.28 (m, 2H), 6.83-6.79 (m, 2H), 5.34 (t, J=8.7 Hz, 1H), 4.66-4.52 (m, 4H), 3.75 (s, 3H), 3.50 (t, J=9.6 Hz, 1H, NH), 3.09-3.00 (m, 4H). ¹³C NMR (125 MHz, CDCl₃) δ 160.2, 133.8 (d, J=8.4 Hz), 132.4 (d, J=6.5 Hz), 131.6 (d, J=8.4 Hz, 2C), 128.7 (2C), 128.6 (2C), 128.5 (2C), 128.3 (2C), 128.0 (2C), 127.5 (d, J=6.4 Hz), 126.6, 126.4, 126.3, 125.9 (2C), 125.8 (2C), 125.2 (d, J=4.0 Hz), 123.4 (d, J=7.5 Hz), 120.1 (d, J=4.0 Hz), 114.5 (2C), 55.3, 46.9, 46.7 (d, J=4.5 Hz), 46.1 (d, J=5.4 Hz), 44.7 (d, J=11.9 Hz), 44.0 (d, J=12.9 Hz). ³¹P NMR (202 MHz, CDCl₃) δ 22.5. HRMS (ESI): m/z calcd for C₃₃H₃₁N₄O₂PNa, 569.2077. Found, 569.2070. Ee: 97.6% (retention time=6.06 (minor) and 6.88 (major), flow rate=0.60 ml/min, OD-H chiral column (7:3 hexane:IPA solvent system). Compound 12g Off-white solid, Yield (0.101 g, 94%); mp 180-182° C., [α]_{D}²⁴=+3.30 (c 1.1, CHCl₃); ¹H NMR (500 MHz, CDCl₃) δ 8.21 (d, J=8.2 Hz, 1H), 8.11 (d, J=8.1 Hz, 1H), 7.86-7.83 (m, 2H), 7.79-7.76 (m, 2H), 7.54-7.29 (m, 10H), 7.13-7.05 (m, 2H), 5.64 (t, J=9.8 Hz, 1H), 4.66-4.39 (m, 4H), 3.95 (t, J=10.0 Hz, 1H, NH), 2.99 (d, J=10.7 Hz, 4H). ¹³C NMR (125 MHz, CDCl₃) δ 160.9, 158.9, 133.72 (d, J=4.9 Hz, 2C), 132.29 (d, J=6.9 Hz), 132.23 (d, J=8.4 Hz), 131.6 (d, J=8.9 Hz), 131.3 (d, J=8.4 Hz), 128.7 (d, J=2.5 Hz), 128.6 (d, J=3.5 Hz, 2C), 128.4 (d, J=12.4 Hz, 2C), 126.6, 126.4 (2C), 126.3, 126.2 (2C), 125.8 (d, J=6.9 Hz, 2C), 125.1 (d, J=4.9 Hz, 2C), 125.0 (d, J=3.5 Hz), 123.3 (d, J=10.9 Hz, 2C), 116.2 (d, J=20.3 Hz), 46.3 (d, J=4.9 Hz), 46.1 (d, J=4.9 Hz), 44.1 (dd, J=20.3, 12.9 Hz, 2C), 42.6. ³¹P NMR (202 MHz, CDCl₃) δ 22.0. HRMS (ESI): m/z calcd for C32H28FN4OPNa, 557.1877; found, 557.1886. Ee: 96.1% (retention time=6.52 (minor) and 7.04 (major), flow rate=0.60 ml/min, OD-H chiral column (7:3 hexane:IPA solvent system). Compound 12h White solid; Yield (0.135 g, 94%); mp 128-130° C.; [α]_{D}²⁵=+7.7° (c 1.1, CHCl₃). ¹H NMR (500 MHz, CDCl₃): 8.19 (d, J=8.5 Hz, 1H), 8.11 (d, J=8.0 Hz, 1H), 7.85 (d, J=7.5 Hz, 2H), 7.77 (d, J=8.0 Hz, 2H), 7.60-7.57 (m, 2H), 7.54-7.37 (m, 8H), 7.33-7.30 (m, 1H), 7.21-7.18 (m, 1H), 5.77 (t, J=9.5 Hz, 1H), 4.64 (dd, J=6.5 Hz, 14.5 Hz, 1H), 4.57 (t, J=6 Hz, 2H), 4.36 (dd, J=6.5 Hz, 15 Hz, 1H), 3.88 (t, J=10 Hz, 1H), 3.03-2.94 (m, 4H); ¹³C NMR (125 MHz, CDCl₃): 135.0 (d, J=5.0 Hz), 133.8 (d, J=8.9 Hz, 2C), 132.4, 132.3 (d, J=3.4 Hz), 132.2, 131.6 (d, J=6.4 Hz), 130.9 (s, 2C), 129.3 (s, 2C), 128.6 (d, J=1.4 Hz, 2C), 128.4 (t, J=3.0 Hz, 2C), 126.5 (d, J=4.9 Hz, 2C), 126.3 (s, 2C), 125.8 (d, J=5.4 Hz, 2C), 125.2 (d, J=9.9 Hz, 2C), 123.4 (d, J=5.5 Hz, 2C), 122.6, 118.8 (d, J=5.4 Hz), 47.8 (d, J=2 Hz), 46.4 (t, J=5.9 Hz, 2C), 44.2 (dd, J=6.0 Hz, 12.9 Hz, 2C); ³¹P NMR (202 MHz, CDCl₃): 22.1. HRMS (ESI): m/z calcd for C₃₂H₂₉BrN₄OP, 595.1257. Found, 595.1253. Ee: 97% (retention time=6.49 (minor) and 6.95 (major), flow rate=0.60 ml/min, OD-H chiral column (7:3 hexane: IPA solvent system). Compound 12i White solid, Yield (0.146 g, 90%); mp 220-222° C., [α]_{D}²⁴=+4.50 (c 1.1, CHCl₃); ¹H NMR (500 MHz, CDCl₃) δ 8.19 (d, J=8.2 Hz, 1H), 8.10 (d, J=8.3 Hz, 1H), 7.84 (d, J=7.8 Hz, 2H), 7.77 (d, J=8.1 Hz, 2H), 7.60 (dd, J=2.0, 7.2 Hz, 1H), 7.53-7.37 (m, 9H), 7.28-7.22 (m, 2H), 5.76 (t, J=9.8 Hz, 1H), 4.63 (dd, J=6.5, 14.8 Hz, 1H), 4.55 (d, J=6.3 Hz, 2H), 4.36 (dd, J=6.2, 14.8 Hz, 1H), 4.13 (t, J=10.0 Hz, 1H, NH), 3.04-2.96 (m, 4H). ¹³C NMR (125 MHz, CDCl₃) δ 133.72 (d, J=1.5 Hz), 133.44 (d, J=4.9 Hz), 132.7, 132.3 (d, J=6.9 Hz), 132.2 (d, J=7.4 Hz), 131.6 (d, J=6.9 Hz), 130.6 (d, J=32.3 Hz, 2C), 129.1 (2C), 128.6 (2C), 128.4 (d, J=5.4 Hz, 2C), 127.8 (2C), 126.4 (2C), 126.3 (d, J=20.8 Hz, 2C), 125.8 (d, J=4.9 Hz, 2C), 125.2 (d, J=9.4 Hz, 2C), 123.3 (d, J=7.9 Hz, 2C), 118.8 (d, J=5.5 Hz), 46.4 (d, J=4.9 Hz), 46.2 (d, J=4.9 Hz), 45.6 (d, J=2.5 Hz), 44.2 (d, J=2.9 Hz), 44.1 (d, J=2.9 Hz). ³¹P NMR (202 MHz, CDCl₃) δ 22.3. HRMS (ESI): m/z calcd for C₃₂H₂₉ClN₄OP, 551.1761. Found, 551.1757. Ee: 95.2% (retention time=6.28 (minor) and 6.82 (major), flow rate=0.60 ml/min, OD-H chiral column (7:3 hexane:IPA solvent system). Compound 12j White solid, Yield (0.152 g, 92%); mp 204-206° C., [α]_{D}²⁴=+3.50 (c 1.1, CHCl₃); ¹H NMR (500 MHz, CDCl₃) δ 8.31 (d, J=7.2 Hz, 1H), 8.18 (d, J=8.0 Hz, 1H), 7.88-7.78 (d, J=7.8 Hz, 7H), 7.50-7.26 (m, 10H), 5.56 (t, J=9.8 Hz, 1H), 4.46-4.14 (m, 4H), 3.52 (t, J=10.0 Hz, 1H, NH), 3.04-2.96 (m, 4H), 2.41 (s, 3H). ¹³C NMR (125 MHz, CDCl₃) δ 135.6, 133.7 (d, J=4.9 Hz), 132.3, 131.7 (d, J=6.9 Hz), 131.4 (2C), 129.4 (2C), 128.6 (2C), 128.4 (d, J=5.4 Hz, 2C), 128.2, 126.9 (d, J=7.5 Hz, 2C), 126.6 (2C), 126.4 (d, J=20.8 Hz, 2C), 126.3 (d, J=4.9 Hz, 2C), 125.8, 125.1 (d, J=9.0 Hz, 2C), 123.6, 123.4, 123.3, 46.9 (d, J=4.9 Hz), 46.6 (d, J=4.9 Hz), 46.3 (d, J=2.5 Hz), 44.3 (t, J=2.9 Hz), 43.9 (d, J=3.0 Hz), 19.0. ³¹P NMR (202 MHz, CDCl₃) δ 22.3. Ee: 98.9% (retention time=6.13 (minor) and 6.68 (major), flow rate=0.60 ml/min, OD-H chiral column (7:3 hexane:IPA solvent system). Compound 12k White solid; yield (0.156 g, 89%), mp 148-150° C. [α]_{D}²⁵+1.74 (c 1.1, CHCl₃); ¹H NMR (500 MHz, CDCl₃) δ 8.25 (d, J=8.5 Hz, 1H), 8.19-8.17 (m, 1H), 7.88-7.84 (m, 2H), 7.79 (t, J=7.0 Hz, 2H), 7.55-7.47 (m, 6H), 7.43-7.39 (m, 2H), 7.37-7.36 (m, 1H), 6.46-6.45 (m, 1H), 6.35-6.34 (m, 1H), 5.60 (t, J=9.5 Hz, 1H), 4.65-4.53 (m, 4H), 3.62 (t, J=10.0 Hz, 1H), 3.03-2.93 (m, 4H); ¹³C NMR (125 MHz, CDCl₃) δ 147.5 (d, J=6.4 Hz), 143.8, 133.8 (d, J=7.8 Hz), 132.3, 131.7 (d, J=7.3 Hz), 128.7, 128.4, 126.9, 126.5 (d, J=13.4 Hz), 125.9 (d, J=7.8 Hz), 125.2 (d, J=5.9 Hz), 123.4 (d, J=9.3 Hz), 117.9 (d, J=4.4 Hz), 46.6 (d, J=5.0 Hz), 46.1 (d, J=5.3 Hz), 44.4 (d, J=12.8 Hz), 43.9 (d, J=13.3 Hz), 41.9 (d, J=1.0 Hz). ³¹P NMR (202 MHz; CDCl₃) δ 21.6. HRMS (ESI): m/z calcd for C₃₀H₂₇N₄O₂PNa, 529.1764. Found, 529.1761. Ee: 99% (retention time=6.55 (minor) and 6.83 (major), flow rate=0.60 ml/min, OD-H chiral column (7:3 hexane:IPA solvent system).

In situ generation and isolation of the above Al-complexes are both covered. Similar procedure is applicable to the use of diol/bionol- and amino alcohol-based systems. It has been confirmed that the reaction of diols and binols with Et₂Al—CN cannot occur at 0° C. Generation of above complexes using diols and bionols at higher temperatures was proven to be necessary.

1. A electrophile for asymmetric Strecker reaction, the electrophile include achiral N-phosphorazides, N-phosphoramides, N-phosphonyl imines and their derivatives, having the structure of formula (I) respectively: 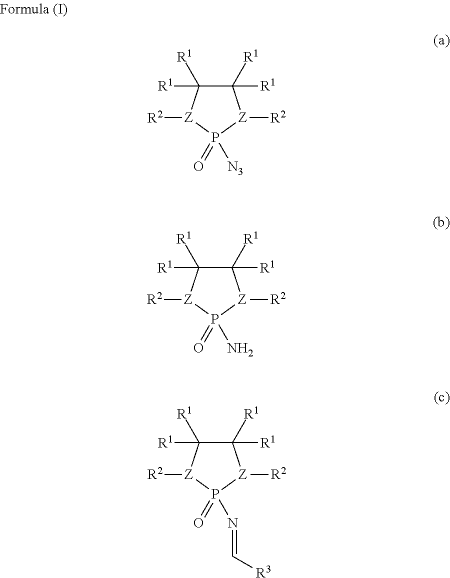
wherein Z═N or CH; R¹ is C1-C20 alkyl, such as i-Pr, Me, Et, Pr, 2-Bu; Aryl; CH₂-Aryl (e.g., Bn); two R¹ groups can be cyclized;
R² is C1-C20 alkyl such as i-Pr, Me, Et, Pr, 2-Bu; Aryl; CH₂-Aryl (e.g., Bn); Ts, Bs, Ms and C1-C20-R—SO₂—, Ar—SO₂—;
R³ is Ar group, such as Ph, 1-Naph-, 2-Naph, 4-Me-Ph, 2-Me-Ph, 4-Cl-Ph, 2-Cl-Ph, 4-Br-Ph, 2-Br-Ph, 4-Br-Ph, 2-Br-Ph, 4-I-Ph, 2-I-Ph, 4-F-Ph, 2-F-Ph, 4-MeO-Ph, 2-MeO-Ph, 4-BnO—Ph, 2-BnO-Ph, 4-AcO-Ph, 2-AcO-Ph, 2-thienyl.

2. The electrophile of claim 1, wherein said derivatives are chiral oxophospholanes and oxophosphepines, where two R²-attached nitrogens are replaced by chiral carbons (H—C*—R²); Five-membered ring can be four- and six-membered rings with two chiral carbon centers directly attached onto phosphorus.

3. The electrophile of claim 2, wherein the said chiral oxophospholanes and oxophosphepines include (2S,5S) or (2R,5R) individual enantiomers of a-f:
g. 1-Oxo-2,5-trans-diaryl-N-(arylmethylene)phospholan-1-amine, 1-oxo-2,5-trans-diaryl-N-(alkylmethylene)phospholan-1-amine, 1-oxo-2,5-trans-dialkyl-N-(arylmethylene)phospholan-1-amine, 1-oxo-2,5-trans-dialkyl-N-(alkylmethylene)phospholan-1-amine;
h. 1-Oxo-2,5-trans-diaryl-N-(arylmethylene)-2,3-dihydro-1H-isophosphindol-1-amine, 1-oxo-2,5-trans-diaryl-N-(alkylmethylene)-2,3-dihydro-1H-isophosphindol-1-amine, 1-oxo-2,5-trans-dialkyl-N-(arylmethylene)-2,3-dihydro-1H-isophosphindol-1-amine, 1-oxo-2,5-trans-dialkyl-N-(alkylmethylene)-2,3-dihydro-1H-isophosphindol-1-amine these imines are indeed derived from 2,5-trans-dialkyl (or diaryl)-2-amino-2-oxo-2,3-dihydro-1H-isophosphindole in which ArCH═N— or RCH═N— substitutes NH2-;
i. 1-Oxo-2,6-trans-diaryl-N-(arylmethylene)phosphinan-1-amine, 1-oxo-2,6-t trans rans-diaryl-N-(alkylmethylene)phosphinan-1-amine, 1-oxo-2,6-trans-dialkyl-N-(arylmethylene)phosphinan-1-amine, 1-oxo-2,6-trans-dialkyl-N-(alkylmethylene)phosphinan-1-amine;
j. 1-Oxo-2,6-trans-diaryl-N-(arylmethylene)-1,4-oxaphosphinan-1-amine, 1-oxo-2,6-trans-diaryl-N-(alkylmethylene)-1,4-oxaphosphinan-1-amine, 1-oxo-2,6-trans-dialkyl-N-(arylmethylene)-1,4-oxaphosphinan-1-amine, 1-oxo-2,6-trans-dialkyl-N-(alkylmethylene)-1,4-oxaphosphinan-1-amine;
k. 1-Oxo-2,6-trans-diaryl-N-(arylmethylene)-2,3-dihydro-1H-phosphenalen-1-amine, 1-oxo-2,6-trans-diaryl-N-(alkylmethylene)-2,3-dihydro-1H-phosphenalen-1-amine, 1-oxo-2,6-trans-dialkyl-N-(arylmethylene)-2,3-dihydro-H-phosphenalen-1-amine, 1-oxo-2,6-trans-dialkyl-N-(alkylmethylene)-2,3-dihydro-1H-phosphenalen-1-amine;
l. Chiral acyclic phosphines such as 1-oxo-N-(arylmethylene)-bis(1′-phenylethyl)-phosphin-1-amine.

4. The electrophile of claim 1, wherein said derivatives are achiral oxophospholanes and oxophosphepines, where two R²-attached nitrogens can also be replaced by achiral carbons (CH₂), i.e., 2,5- or 2,6-alkyl/aryl groups of the above a-f are replaced by hydrogen.

5. The electrophile of claim 1, wherein the “P═O” can be “P═S”.

6. A nucleophile for asymmetric Strecker reaction, the nucleophiles include chiral BINOL-derived azides, amides, imines and their derivatives, having the structure of one of formula (II): 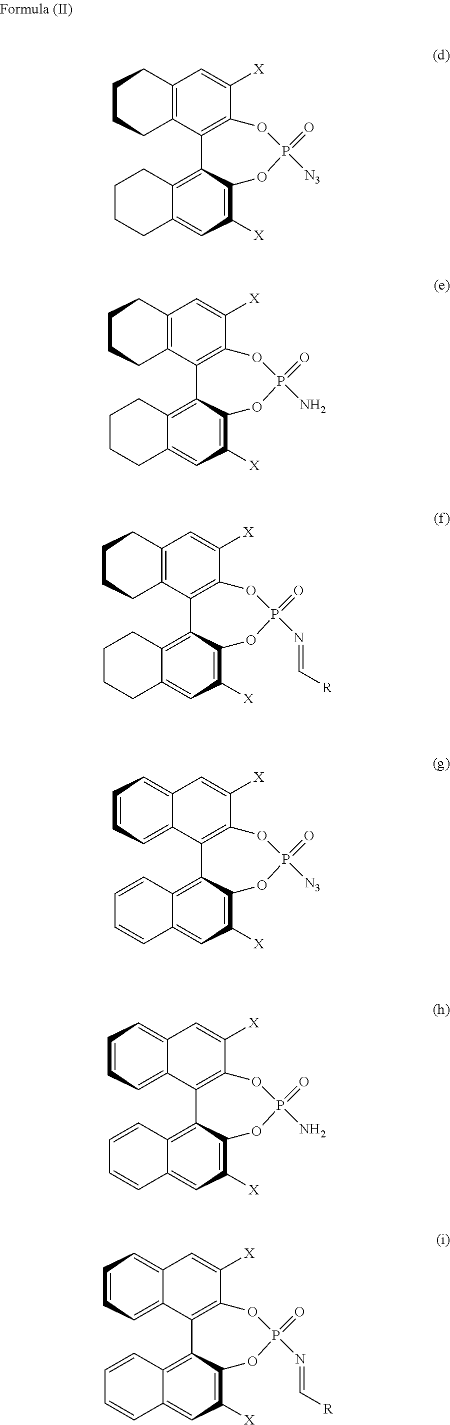
wherein X═H, Alkyl, Aryl group, SiR₃ and SiAr₃; R=alkyl, aryl groups, functional group (such as ester, acetals)-attached alkyl and aryl groups, acetylides; two oxygens of O—P single bonds can be replaced by “N—R” (R=alkyl, aryl groups); two oxygens of O—P single bonds can be replaced “CH₂”; “P═O” can be “P═S” except for (g)-(i) in which X═H; For structure (g) X cannot be H for both P═O and P═S cases.

7. A nucleophile for asymmetric Strecker reaction, the nucleophile include chiral and achiral diol-based cyanides and their derivatives, having the structure of formula (III): 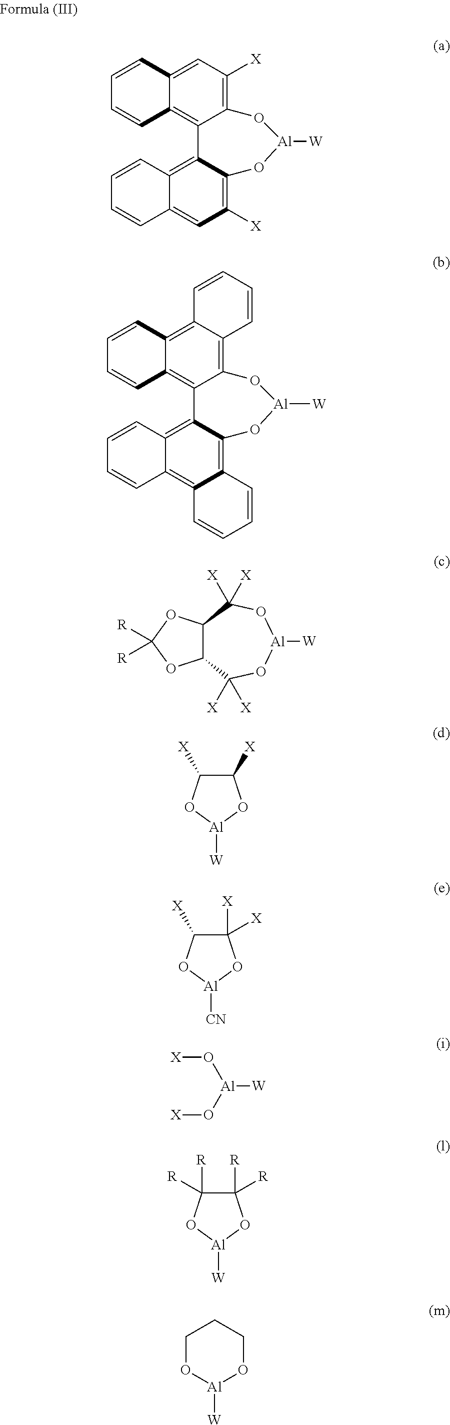 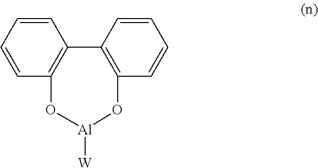
wherein (a)-(b) can be their enantiomers; X=alkyl, aryl, SiR₃ and SiAr₃; W═CN, N₃, I, C≡C—Ar; C≡C—R, C≡C—CH-acetyl; derivatives from 1-(2-hydroxy-5,6,7,8-tetranhydronaphthalen-1-yl)-5, 6,7,8-tetranhydronaphthalen-2-ol are also covered;
(c) can be their enantiomers; X=Aryl, Alkyl, W═CN, N₃, I, C≡C—Ar; C═C—R, C≡C—CH-acetyl; R=Alkyl, Aryl groups; can be different; can be cyclic, two R's are connected;
(d)-(e) can be their enantiomers; and achiral ones where X═H, or, four same X groups are attached on 1,2-positions; X=Alkyl, Aryl, CR₂(—OR); W═CN, N₃, I, C═C—Ar; C═C—R, C═C—CH-acetyl;
in (i) X=Alkyl, Aryl, W═CN, N₃;
in (l)-(n) X=Alkyl, Aryl, COOR; W═CN, N₃, I.

8. The nucleophile for asymmetric Strecker reaction of claim 7, wherein (d) and (e) of Formula (III) having the structure of one of Formula (III-2):

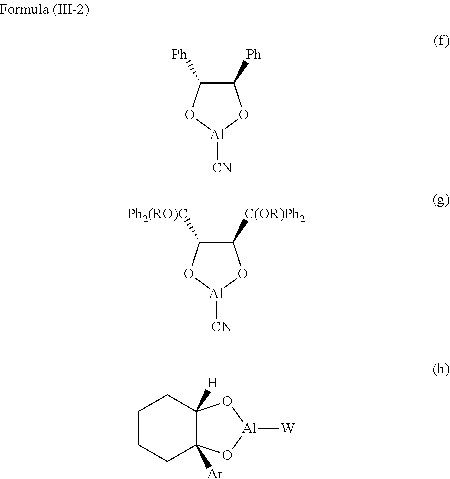

9. The nucleophile for asymmetric Strecker reaction of claim 7, wherein (i) of Formula (III) having the structure of one of Formula (III-3):

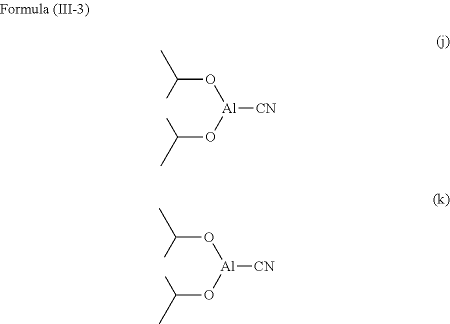

10. The nucleophile for asymmetric Strecker reaction of claim 7, wherein (l), (m) and (n) of Formula (III) having the structure of one of Formula (III-4):

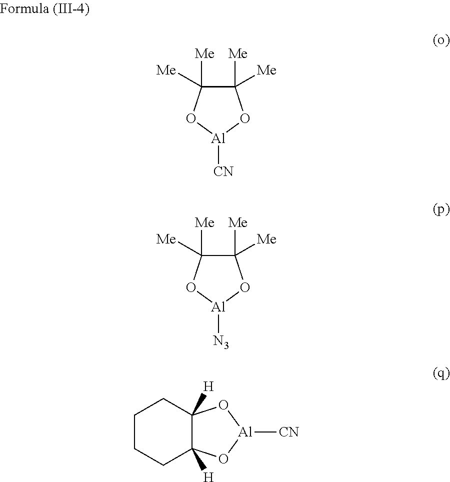

11. A nucleophile for asymmetric Strecker reaction, the nucleophile include chiral and achiral diamine-based cyanides and their derivatives, having the structure of formula (IV): 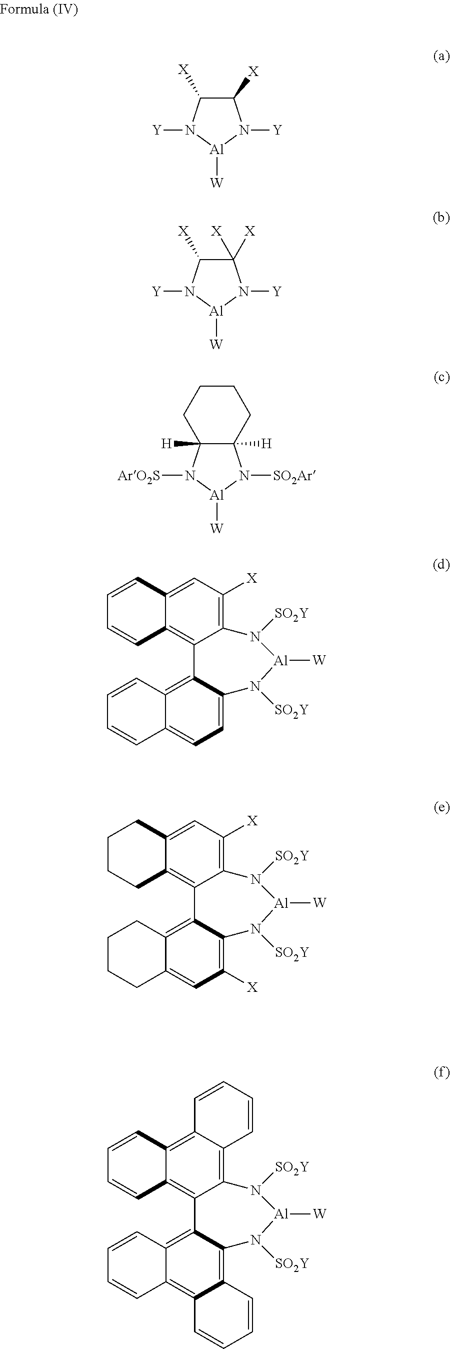
wherein (a)-(b) can be their enantiomers; achiral ones where X═H, or, four identical X groups are attached on 1,2-positions; X=Aryl, Alkyl; Y=alkyl, aryl and RSO2-; W═CN, N₃, I, C≡C—Ar; C≡C—R, C═C—CH-acetyl;
(d)-(f) can be their enantiomers; X=alkyl, aryl, SiR₃ and SiAr₃; Y=alkyl, aryl; W═CN, N₃, I, C≡C—Ar, C≡C—R, C≡C—CH-acetyl; 1,3-diamine-derived complexes are also covered.

12. Nucleophiles for asymmetric Strecker reaction, the nucleophiles include chiral and achiral amino alcohol-based cyanides and their derivatives, having the structure of formula (V): 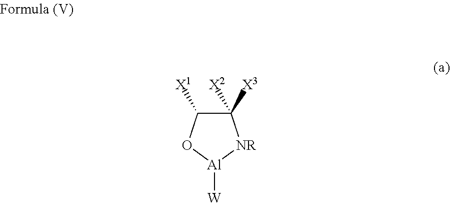
wherein (a) can be their enantiomers; X=Alkyl, Aryl, COOR; W═CN, N₃, I, C≡C—Ar; C═C—R, C≡C—CH-acetyl, R═H, alkyl, ArSO2-, ROCO— and RCO—; and achiral ones where X═H, or to same X groups are attached on alpha, beta positions; 1,3-amino alcohol-derived complexes are also covered.

13. The nucleophiles of claim 12, the formula (V) having the structure of one of formula (V-2)

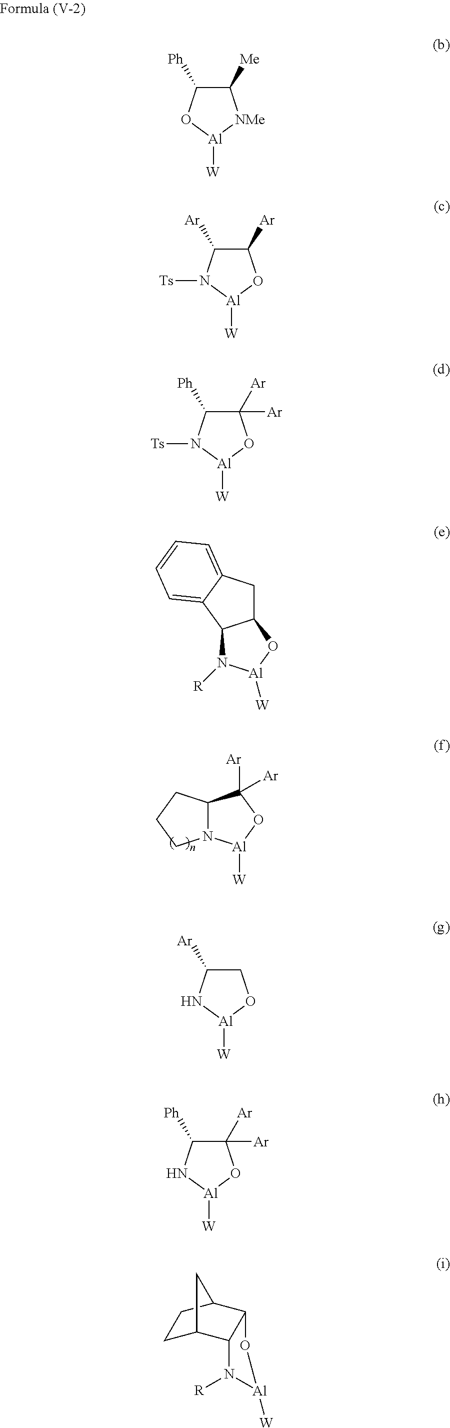

14. Nucleophiles for asymmetric Strecker reaction, the nucleophiles include Strecker nucleophiles that are derived from chiral and achiral hydroxy carboxylic acids and amino acids, having the structure of one of formula (VI): 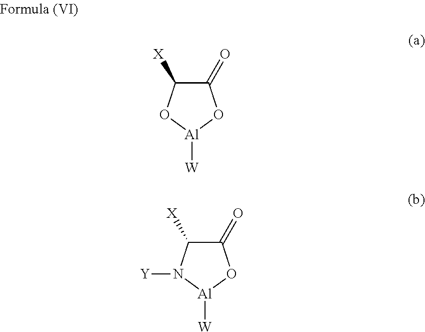
wherein (a) can be their enantiomers; and achiral ones where X═H, or, two same X groups are attached on alpha position; X=alkyl, aryl; W═CN, N₃, I;
(b) can be their enantiomers; and achiral ones where X═H, or two same X groups are attached on alpha position; X=Alkyl, aryl; Y=Alkyl, Aryl, XSO2-; W═CN, N₃, I, C≡C—Ar; C≡C—R, C≡C—CH-acetyl, X═H, alkyl, ArSO2-, ROCO— and RCO—; Beta hydroxy carboxylic acid- and beta amino acid-derived series are also covered.

15. The nucleophiles of claim 14, (b) of formula (VI) having the structure of one of formula

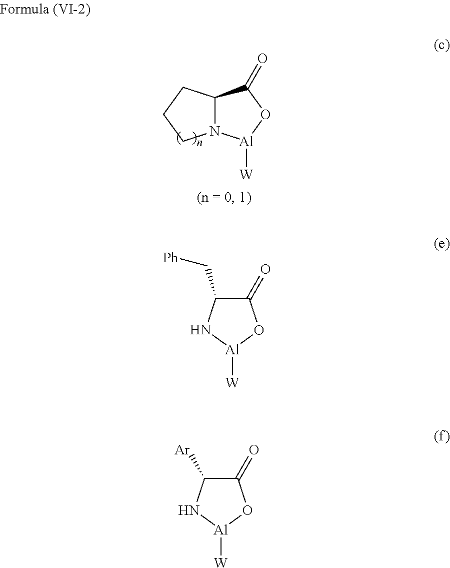

16. A method of forming the electrophile for asymmetric Strecker reaction of claim 1, the method comprise the reaction with steps of: a) synthesizing phosphoryl chloride from achiral diamine; b) synthesizing phosphorous azide; c) synthesizing phosphoramide; d) synthesizing the corresponding achiral N-phosphonyl imines.

17. The method of claim 16, comprise the reaction with steps scheme 1:

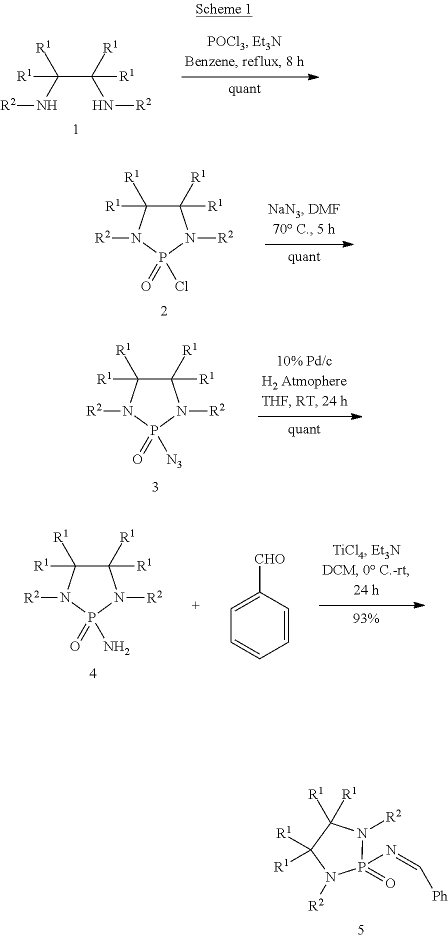

18. A method of forming the nucleophile for asymmetric Strecker reaction of claim 6, comprise the reaction for synthesis of N-phosphoryl azides, amides and imines of scheme 2:

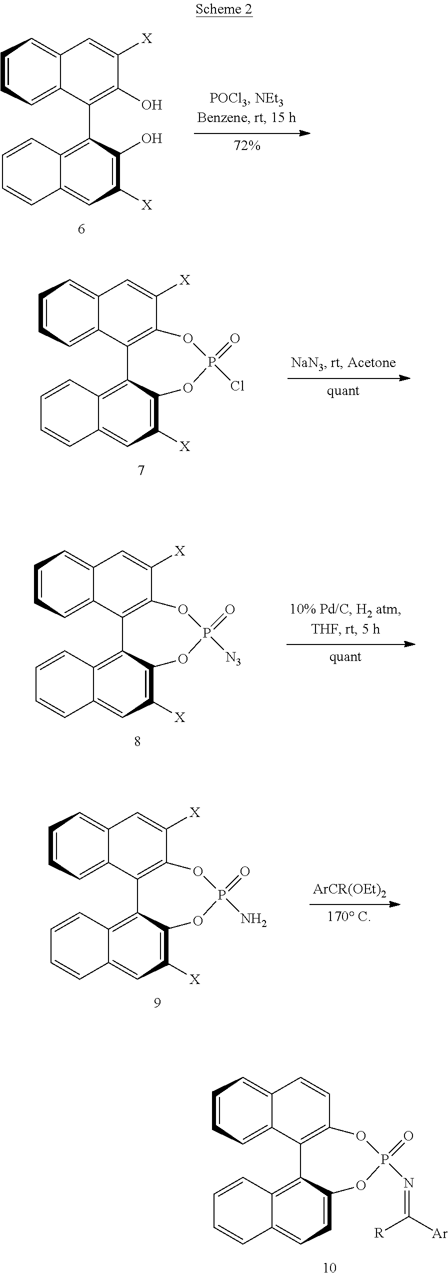

19. The method of claim 18, wherein comprising synthesis of (S)-1,1′-Binaphthyl-2,2′-diyl phosphoramide.

20. A improved asymmetric catalytic and/or stoichiometric Strecker process using the imines of claim 1, comprises the reaction of scheme 3:

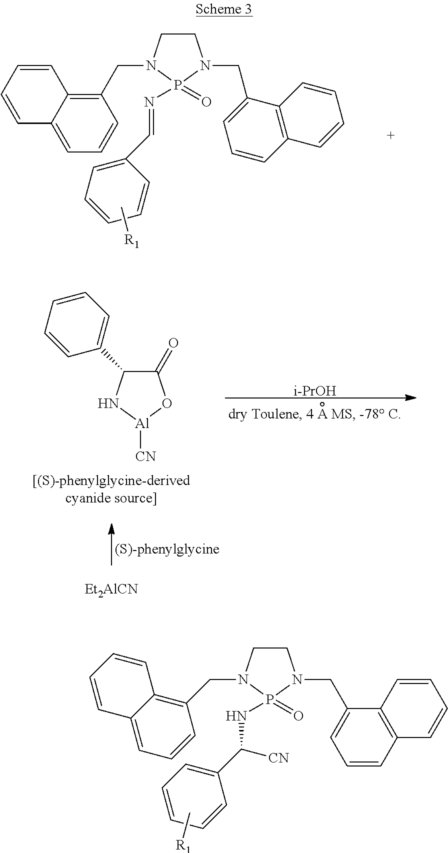

21. The Strecker process of claim 20, wherein comprising synthesis of N-phosphonyl substituted chiral α-aminonitriles.

22. The Strecker process of claim 20, wherein using situ generation and isolation of the Al-complexes.

23. The Strecker process of claim 20, wherein using diol/bionol- and amino alcohol-based systems and the reaction of diols and binols with Et₂Al—CN cannot occur below 0° C.
